(19) United States
(12) Patent Application Publication
(10) Pub. No.: US 2026/0075091 A1
(43) Pub. Date: Mar. 12, 2026

(54) AUTOMATED TARGETED REMEDIATION OF PHISHING WEBSITES

(71) Applicant: Royal Bank of Canada, Toronto (CA)

(72) Inventors: Adam Hulcoop, Whitby (CA); Mackenzie Preston, Toronto (CA); Jahanrajkar Singh, Brampton (CA); Felix Kurmish, Nepean (CA)

(21) Appl. No.: 19/323,855

(22) Filed: Sep. 9, 2025

Related U.S. Application Data
(60) Provisional application No. 63/692,836, filed on Sep. 10, 2024.
(60) Provisional application No. 63/829,085, filed on Jun. 24, 2025.

(51) Int. Cl. H04L 9/40

(52) U.S. Cl. CPC H04L 63/1483; H04L 63/1416

(57) ABSTRACT

A computer-implemented method for remediation targeting a threat actor computer system collects ongoing threat actor signals from a plurality of input channels, processes the threat actor signals to instantiate threat actor detections from the threat actor signals and stores the threat actor detections in a data repository as part of threat actor activity data maintained within the data repository. The threat actor detections are analyzed to identify threat actor computer system(s). Abiotic digital scouting agents perform covert digital reconnaissance of the threat actor computer system(s) according to a scouting protocol to identify respective characteristics of the threat actor computer system(s). The characteristics identified by the abiotic digital scouting agents are used to determine a seeding protocol, and abiotic digital scouting agents are used to seed a plurality of synthetic user identities into the threat actor computer system(s). After seeding, the method continues collecting ongoing threat actor signals.

### CROSS-REFERENCE TO RELATED APPLICATIONS

The present application claims priority to, and the benefit of, U.S. Provisional Application No. 63/692,836 filed on Sep. 10, 2024 and U.S. Provisional Application No. 63/829,085 filed on Jun. 24, 2025, the teachings of each of which are hereby incorporated by reference.

### TECHNICAL FIELD

The present disclosure relates to computer security, and more particularly to disrupting phishing by automated targeting of phishing websites.

### BACKGROUND

The term “phishing” refers to a type of fraud used to manipulate individuals into activating a link to a malicious website. These malicious websites may install malware on a user's computing device, or may impersonate the website of a legitimate merchant or financial institution to deceive the victim into entering sensitive information, such as logins, passwords, or bank account and credit card numbers.

The term “phishing” is derived from “fishing” and, like the latter, relies on “bait”. The bait may take the form of an e-mail, text message or the like purporting to be from a trusted party, such as a bank or other financial institution, or an e-commerce or entertainment platform.

In one common example, a message may purport to come from a bank or other financial institution, claiming that the person's account has been locked, and providing a link for the person to “unlock” their account. The link will take the person to a website that is designed to mimic the bank's website, with fields for the user to enter their credentials (e.g. user name and password, and possibly bank account details). In fact, the website is fraudulent, and once the user has provided their details, these are captured for use by the miscreant operators in conducting illicit transactions with the user's account, which may be drained before the treachery is discovered.

Another common example is for the scoundrels to send a message claiming to be from an e-commerce or entertainment platform, and alleging that there was a problem with a payment. Again, a link is provided, which takes the recipient to an imposter website, where they are asked to enter login information and payment information, which is captured and put to misuse.

These are merely a few common examples, and are by no means limiting; there are a wide range of phishing schemes in use and more are being developed. The resourcefulness of greedy, dastardly blackguards knows few bounds, and the messages can be highly manipulative and effective. Thus, it is an ongoing challenge to defend against phishing.

Many existing security products are of limited effectiveness in protecting clients from phishing attacks. They take a broad approach, and typically do not prioritize a user's financial accounts, which may create exposure to more sophisticated attacks that are targeted to users of a particular financial institution.

Those financial institutions may in turn deploy “threat hunters”, who seek to detect these phishing websites and disrupt their operations. Despite their dedication, there remain potential blind spots, and there can also be a delay between when a phishing website goes “live” and when it is detected and neutralized. The threat actors can use this delay to “phish” the clients of a financial institution before the phishing website is identified and taken down.

### SUMMARY

In one aspect, a computer-implemented method for obstructing phishing comprises generating a pool of synthetic user identities, wherein each synthetic user identity comprises a set of user credentials, with the set of user credentials including a numerical identifier having the same number of digits as a predefined structure. The pool of synthetic user identities comprises at least one of (a) a set of pseudo-genuine synthetic user identities wherein, for each pseudo-genuine synthetic user identity in the set of pseudo-genuine synthetic user identities, the numerical identifier of that pseudo-genuine synthetic user identity passes all authentication tests corresponding to the predefined structure, and (b) a set of deficient synthetic user identities wherein, for each deficient synthetic user identity in the set of deficient synthetic user identities, the numerical identifier of that deficient synthetic user identity passes only some of the authentication tests corresponding to the predefined structure. The method further comprises using the user credentials to seed a plurality of the synthetic user identities from the pool into a phishing website impersonating a genuine login page.

In preferred embodiments, the set of user credentials further comprises a password.

In some embodiments, the pool of synthetic user identities comprises only the set of pseudo-genuine synthetic user identities. In other embodiments, the pool of synthetic user identities comprises only the set of deficient synthetic user identities. In yet other embodiments, the pool of synthetic user identities comprises both the set of pseudo-genuine synthetic user identities and the set of deficient synthetic user identities, and the plurality of the synthetic user identities from the pool that are seeded into the phishing website comprises at least a subset of the set of pseudo-genuine synthetic user identities and at least a subset of the set of deficient synthetic user identities.

In preferred embodiments, each synthetic user identity is seeded only once.

In some embodiments, the numerical identifiers for the set of pseudo-genuine synthetic user identities are blacklisted transaction card numbers that are otherwise fully compliant with the predefined structure.

In some embodiments, the method may further comprise monitoring, at a server system hosting the genuine login page, for login attempts for which the synthetic user identities are used for the login attempts, comparing the synthetic user identities that are used for the login attempts to an entire set of the synthetic user identities that were seeded into the phishing website, and determining, from the comparison, behaviour characteristics of a threat actor associated with the phishing website. In some particular embodiments, each of the synthetic user identities further comprises a set of user fingerprint characteristics, and comparing the synthetic user identities that are used for the login attempts to the entire set of the synthetic user identities that were seeded into the phishing website comprises comparing the user fingerprint characteristics of the synthetic user identities that are used for the login attempts to the user fingerprint characteristics of the entire set of the synthetic user identities that were seeded into the phishing website. Using the user credentials to seed the plurality of the synthetic user identities from the pool into the phishing website may comprise an agent presenting the user fingerprint characteristics to the phishing website.

In another aspect, a computer-implemented method for obstructing phishing comprises generating a pool of synthetic user identities, wherein each synthetic user identity comprises a set of user credentials, the set of user credentials including an identifier and a password, using the user credentials to seed a plurality of the synthetic user identities from the pool into a phishing website impersonating a genuine login page, monitoring, at a server system hosting the genuine login page, for login attempts for which the synthetic user identities are used for the login attempts, comparing the synthetic user identities that are used for the login attempts to an entire set of the synthetic user identities that were seeded into the phishing website, and determining, from the comparison, behaviour characteristics of a threat actor associated with the phishing website.

In preferred embodiments, each of the synthetic user identities further comprises a set of user fingerprint characteristics, and comparing the synthetic user identities that are used for the login attempts to the entire set of the synthetic user identities that were seeded into the phishing website comprises comparing the user fingerprint characteristics of the synthetic user identities that are used for the login attempts to the user fingerprint characteristics of the entire set of the synthetic user identities that were seeded into the phishing website.

In some embodiments, using the user credentials to seed the plurality of the synthetic user identities from the pool into the phishing website comprises an agent presenting the user fingerprint characteristics to the phishing website.

In some embodiments, the pool of synthetic user identities comprises at least one of (a) a set of pseudo-genuine synthetic user identities wherein, for each pseudo-genuine synthetic user identity in the set of pseudo-genuine synthetic user identities, the identifier of that pseudo-genuine synthetic user identity passes all authentication tests associated with the identifier, and (b) a set of deficient synthetic user identities wherein, for each deficient synthetic user identity in the set of deficient synthetic user identities, the identifier of that deficient synthetic user identity passes only some of the authentication tests associated with the identifier.

In some preferred embodiments, the identifier is an e-mail address, and the authentication tests associated with the e-mail address consist of a structural test and a response test.

In a further aspect, the present disclosure is directed to a computer-implemented method for remediation targeting a threat actor computer system. The method comprises automatically collecting ongoing threat actor signals from a plurality of input channels, and automatically processing the threat actor signals to instantiate threat actor detections from the threat actor signals and storing the threat actor detections in a data repository as part of threat actor activity data maintained within the data repository. The method further comprises automatically analyzing the threat actor detections in the data repository to select at least one threat actor computer system. The method still further comprises automatically using abiotic digital scouting agents to perform covert digital reconnaissance of the threat actor computer system(s) according to a scouting protocol to identify respective characteristics of the at least one threat actor computer system, automatically using the characteristics of the threat actor computer system(s) identified by the abiotic digital scouting agents to determine a seeding protocol, automatically using abiotic digital seeding agents to seed a plurality of synthetic user identities into the threat actor computer system(s), and returning to the step of automatically collecting the ongoing threat actor signals from the plurality of input channels.

In some embodiments, the method further comprises, before using the abiotic digital scouting agents to perform the covert digital reconnaissance of the threat actor computer system(s), automatically determining the scouting protocol for the abiotic digital scouting agents based on the respective threat actor signals for the threat actor computer system(s).

In some embodiments, the threat actor signals comprise at least one of malicious website URLs, detected threat actor activity, compromised code beacons and compromised user credentials.

In some embodiments, the input channels comprise at least two of at least one phishing-site detection product, at least one anti-phishing software product, at least one abuse feed, and at least one login attempt. In some such embodiments, the threat actor signals are obtained from the at least one login attempt by monitoring, at a server system hosting the genuine login page, for login attempts for which the synthetic user identities are used for the login attempts, comparing the synthetic user identities that are used for the login attempts to an entire set of the synthetic user identities that were seeded into the at least one threat actor computer system, and determining, from the comparison, behaviour characteristics of at least one respective threat actor associated with the threat actor computer system(s).

In some embodiments, the threat actor activity data in the data repository is asynchronously enriched with additional data. In some such embodiments, the additional data comprises one or more of IP lookup meta-data, compromised user type, and validity.

In some embodiments, the threat actor detections are represented as generalized models with reusable enrichment processes and including bespoke fields for each of a plurality of detection types using hierarchical schemas.

In some embodiments, the threat actor signals are phishing signals and the threat actor detections are phishing detections.

In some embodiments, the threat actor signals comprise compromised credential detections and the threat actor detections are instantiated from the compromised credential detections.

In further aspects, the present disclosure is directed to a data processing system comprising at least one processor and memory coupled to the at least one processor, wherein the memory contains instructions which, when executed by the at least one processor, cause the data processing system to carry out any of the above-described methods.

In yet further aspects, the present disclosure is directed to a computer program product comprising at least one tangible, non-transitory computer-readable medium embodying instructions which, when executed by at least one processor of a data processing system, cause the data processing system to carry out any of the above-described methods.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

These and other features will become more apparent from the following description in which reference is made to the appended drawings wherein:

FIG. 1 shows a computer network that comprises an example embodiment of a system for conducting electronic financial transactions;

FIG. 2 depicts an example embodiment of a server in a data center;

FIG. 3 shows the computer network of FIG. 1 where users thereof are targeted by a phishing attack;

FIG. 4 is a flow chart showing an illustrative computer-implemented method for obstructing phishing;

FIG. 5 an illustrative diagram showing a schematic architecture overview for a computer-implemented system for obstructing phishing;

FIG. 6 is a flow chart showing an illustrative computer-implemented method for remediation targeting a threat actor computer system;

FIG. 7 is an illustrative diagram showing a schematic architecture overview for a computer-implemented system for remediation targeting a threat actor computer system; and

FIG. 8 shows a pictorial representation of illustrative methods of proactively detecting misappropriation of website source code using compromised code beacons.

### DETAILED DESCRIPTION

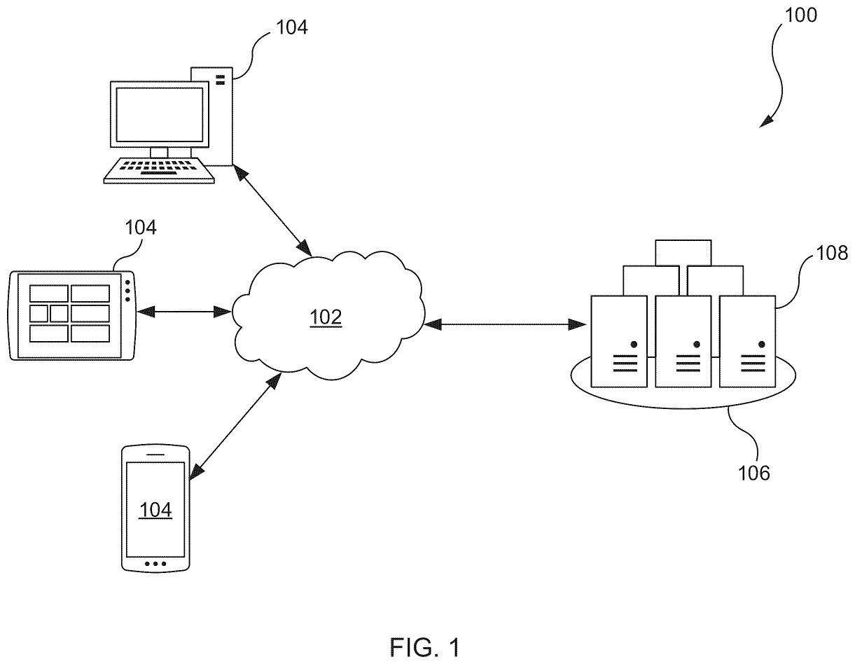

Referring now to FIG. 1, there is shown a computer network 100 that comprises an example embodiment of a system for conducting electronic financial transactions. More particularly, the computer network 100 comprises a wide area network 102 such as the Internet to which various client devices 104, an ATM 110, and data center 106 are communicatively coupled. The data center 106 comprises a number of servers 108 networked together to collectively perform various computing functions. For example, in the context of a financial institution such as a bank, the data center 106 may host online banking services that permit users to log in to those servers using user accounts that give them access to various computer-implemented banking services, such as online fund transfers. Furthermore, individuals may appear in person at the ATM 110 to withdraw money from bank accounts controlled by the data center 106.

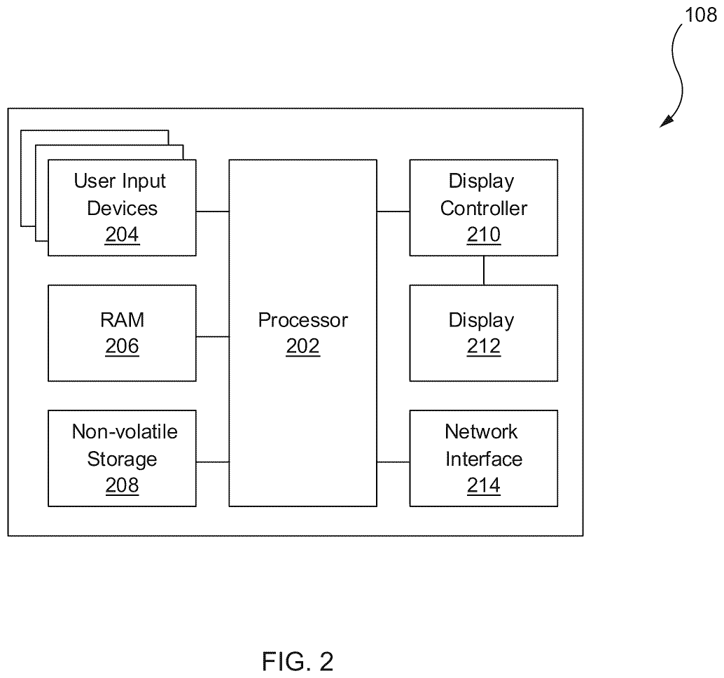

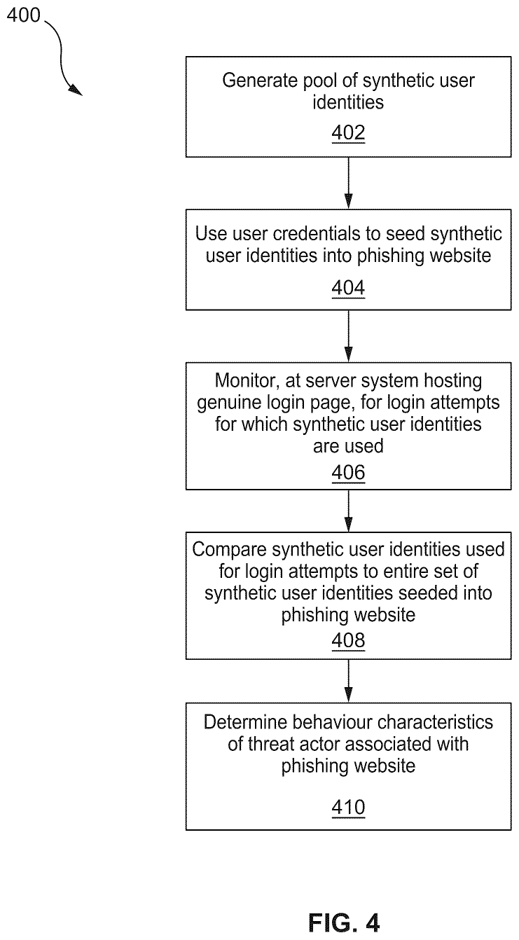

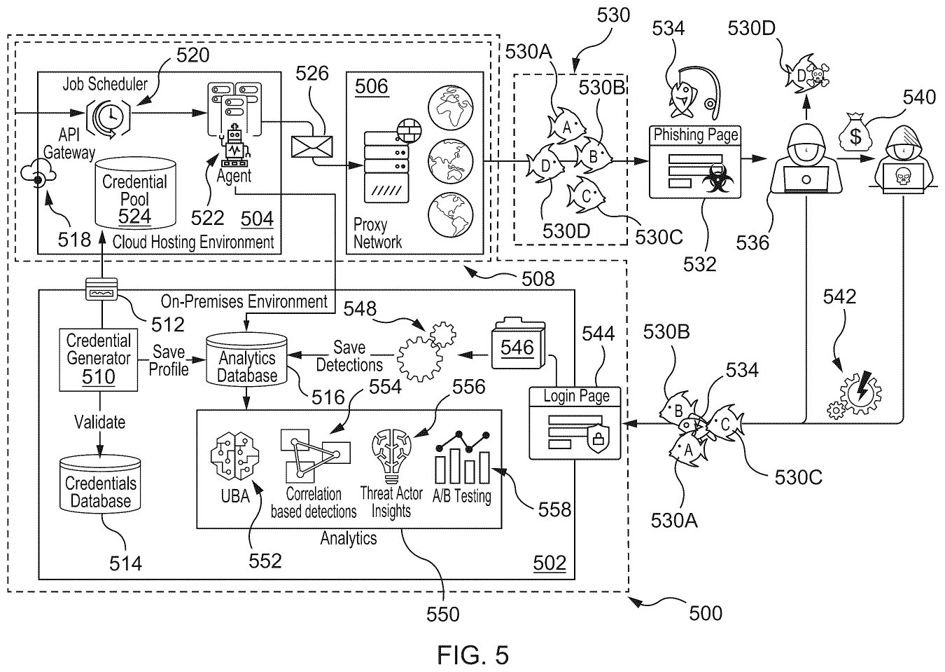

Referring now to FIG. 2, there is depicted an example embodiment of one of the servers 108 that comprises the data center 106. The server comprises a processor 202 that controls the overall operation of the server 108. The processor 202 is communicatively coupled to and controls several subsystems. These subsystems comprise user input devices 204, which may comprise, for example, any one or more of a keyboard, mouse, touch screen, voice control; random access memory (“RAM”) 206, which stores computer program code for execution at runtime by the processor 202; non-volatile storage 208, which stores the computer program code loaded into the RAM 206 at runtime; a display controller 210, which is communicatively coupled to and controls a display 212; and a network interface 214, which facilitates network communications with the wide area network 102 and the other servers 108 in the data center 106. The non-volatile storage 208 has stored on it computer program code that is loaded into the RAM 206 at runtime and that is executable by the processor 202. When the computer program code is executed by the processor 202, the processor 202 causes the server 108 to implement aspects of a method for obstructing phishing websites, for example as described in more detail in respect of FIGS. 4 and 5 below. Additionally or alternatively, the servers 108 may collectively perform that method using distributed computing, or may cooperate with one or more cloud computing environments to do so. While the system depicted in FIG. 2 is described specifically in respect of one of the servers 108, analogous versions of the system may also be used for the client devices 104.

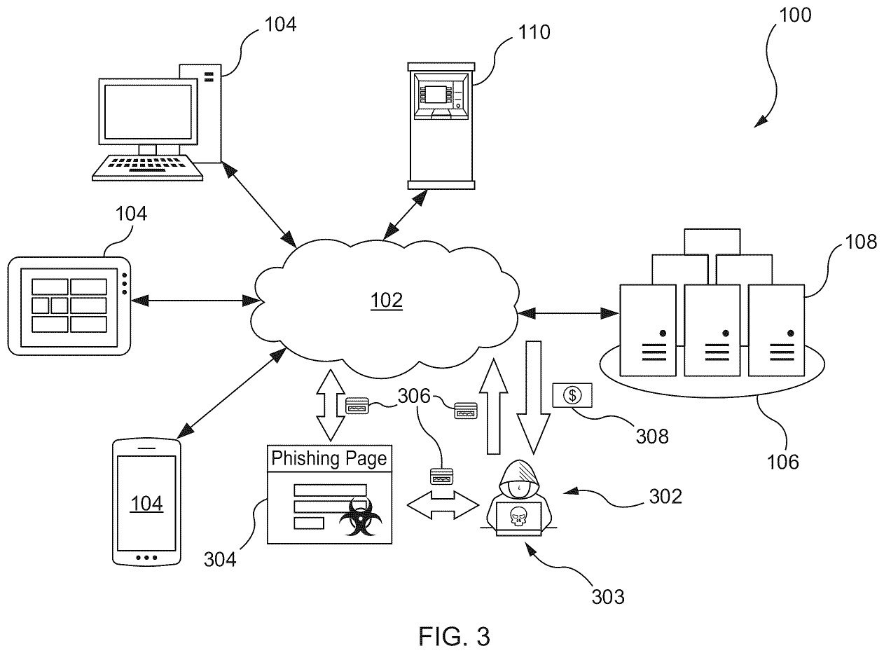

Reference is now made to FIG. 3, which shows the computer network 100 of FIG. 1 where users thereof are targeting by a phishing attack. As noted above, the data center 106 may host online banking services that permit users to log in to those servers using user accounts that give them access to various computer-implemented banking services, such as online fund transfers. This presents an inviting target for threat actors.

A threat actor 302 operates a threat actor computer system 303 hosting a phishing website 304. The phishing website 304 presents a phishing page that seeks to impersonate the genuine login page for a financial institution whose online banking services are hosted by the data center 106. Where users are deceived, they will use their client devices 104 to enter their credentials 306 into the phishing website 304, and these credentials 306 are then captured by the threat actor 302. The threat actor 302 can then connect to the data center 106 through the wide area network 102 and use the captured credentials 306 to access the users' financial accounts to the detriment of the users, for example by transferring the users' funds 308 to the threat actor 302. While only a single threat actor 302 is shown in FIG. 3, this is merely for simplicity of illustration, and in practice there may be multiple threat actors. For example, one threat actor may capture the credentials and then sell the captured credentials to another threat actor (who may in turn further sell the captured credentials), so that the threat actor who ultimately uses the captured credentials to access the users' financial accounts is not necessarily the same threat actor who captured the credentials. Moreover, there may be multiple independent threat actors using multiple independent threat actor computer systems to host multiple independent phishing websites.

Technology according to the present disclosure seeks to perform remediation targeting a threat actor computer system, for example to obstruct phishing, and may have the further benefit of enabling an institution targeted by phishing to profile threat actor behaviour and develop characteristics that will be used to detect and prevent unauthorized attempts to access accounts in existing client traffic.

Reference is now made to FIG. 4, which is a flow chart showing an illustrative computer-implemented method 400 for obstructing phishing. The term “obstructing” is used in a broad sense. As used herein, “obstructing phishing” includes disruption of phishing operations (for example by diluting the credentials of real victims who were duped by the phishing website with synthetic and harmless credentials so as to reduce the efficacy of the phishing). The term “obstructing phishing” further includes profiling threat actors and identifying operational security failures on the part of the threat actor, which can be leveraged to gain insight into the threat actor's operations; this insight can then be used to detect and prevent phishing by that threat actor.

At step 402, the method 400 generates a pool of synthetic user identities. The user identities are synthetic in that they are created ex nihilo and are not intentionally associated with any actual human person. Each synthetic user identity comprises a set of user credentials including an identifier, and preferably also includes at least a password.

In a preferred embodiment, the identifier is a numerical identifier having the same number of digits as a predefined structure. The numerical identifier is preferably a purported card number for a particular type of transaction card. A transaction card may be, for example, a financial card, such as a bank card or credit card, prepaid card, or another type of benefit card, such as for a loyalty or rewards program. The term “card” as used herein includes a virtual card (where a card number is assigned but there is no physical card created) as well as a physical card (which typically has the card number printed thereon). Where the identifier is a numerical identifier, the user credentials may consist of only the numerical identifier but will preferably also include other credentials, such as one or more of a password, an expiry date, a user name, a personal name, a card type (e.g. an identification of the issuing bank or credit card brand), a Card Verification Value (CVV) number, an e-mail address, and a physical address (which may be a complete address or only a zip code or postal code), among others.

In embodiments where the identifier is not a numerical identifier, the identifier may be, for example, an e-mail address or a non-e-mail username—in many instances of online services, an e-mail address serves as a user name, but in some cases a user may be assigned or may select a user name that is not an e-mail address, such as a screen name. The user names and/or e-mail addresses are preferably synthetic (not corresponding to any real individual). Where the identifier is not a numerical identifier, the user credentials will also include a password, and may also include one or more of a user name (if the identifier is not the user name), an e-mail address (if the identifier is not the e-mail address), a personal name, a credit card number or debit card number, a card type (e.g. an identification of the issuing bank or credit card brand), a Card Verification Value (CVV) number, and a physical address (which may be a complete address or only a zip code or postal code), among others.

As noted above, in embodiments where the identifier is a numerical identifier, the numerical identifier for each set of user credentials is preferably a purported card number for a particular type of transaction card. A card number for a transaction card has a predefined structure. The predefined structure may be, for example, a Primary Account Number (PAN) structure for a financial card or benefit card. A widely used PAN standard is set out in ISO/IEC 7812-1:2017, which is incorporated herein by reference.

Typically a PAN for a bank card or major credit card (e.g. Visa®, MasterCard® and Discover® credit cards) is 16 digits long, although some types of card may have more or fewer digits. For example, American Express® credit cards have 15 digits. In an embodiment in which the predefined structure is a PAN structure, a numerical identifier that is a purported transaction card number will have the same number of digits as the predefined structure when it has a number of digits that is consistent with the PAN structure for that card type. Thus, if the numerical identifier is a purported card number for a Visa®, MasterCard® or Discover® credit card, a numerical identifier having 16 digits will generally have the same number of digits as the predefined structure, whereas if the numerical identifier is a purported card number for an American Express® credit card, a numerical identifier having 15 digits will generally have the same number of digits as the predefined structure. These are merely non-limiting, non-exhaustive examples.

In the ISO/IEC 7812-1:2017 standard, the first digit in the PAN is the Major Industry Identifier (MII), identifying the source industry for the card. The table below sets out certain categories associated with common MIIs.

| MII Digit | |
|---|---|
| Value | Issuer Category |
| 1 | Airline Industry Cards |
| 2 | Airline Industry Cards; Other Industry Assignment |
| 3 | Travel and Entertainment Cards (includes American |
| | Express ® cards) |
| 4 | Banking and Financial (including Visa ®) Cards |
| 5 | Banking and Financial (including some MasterCard ®) Cards |
| 6 | Merchandising and Financial (including some Discover ®) |
| | Cards |
| 7 | Petroleum Industry Cards |
| 8 | Healthcare Cards, Telecommunications, Other Industry |
| | Assignments |
| 9 | National Assignment |

The first six or eight digits in a PAN (including the MII) are the Issuer Identification Number (IIN), also referred to as a Bank Identification Number (BIN). The next set of digits, other than the last digit, is an account number, that is, a number unique to a particular cardholder. The last digit is a checksum used for verification. A valid PAN should pass Luhn verification, the algorithm for which is described in U.S. Pat. No. 2,950,048, granted on Aug. 23, 1960 and incorporated herein by reference. Individual card issuers can layer in additional card number verification schemas if they so choose. Luhn verification is merely a non-limiting example of an authentication test corresponding to the PAN structure, and is not exhaustive; other authentication tests are also contemplated. Of note, the term “authentication test” does not include a transaction test, where a transaction card is tested by attempting an actual transaction, such as a purchase or a balance check.

The pool of synthetic user identities preferably comprises one or both of a set of pseudo-genuine synthetic user identities, and a set of deficient synthetic user identities.

In a case where the identifier is a numerical identifier, the numerical identifier for each pseudo-genuine synthetic user identity passes all authentication tests corresponding to the predefined structure. Thus, where the predefined structure is a PAN structure for a financial card or benefit card, the numerical identifier will pass Luhn verification, and would pass any checksum tests. For example, the numerical identifiers for the set of pseudo-genuine synthetic user identities may be genuine transaction card numbers generated by the issuer and internally blacklisted by the issuer to prevent those transaction card numbers from being used to complete a transaction, but that are otherwise fully compliant with the predefined structure (e.g. Luhn valid and all checksums passed). The numerical identifiers for pseudo-genuine synthetic user identities will not pass a transaction test if they are not actual transaction card numbers (or are blacklisted transaction card numbers), although optionally, numerical identifiers for pseudo-genuine synthetic user identities may be configured to pass some transaction tests as well. For example, subject to compliance with all relevant laws, some pseudo-genuine synthetic user identities may have real credit card numbers as their numerical identifiers, but with a small credit limit (e.g. $50 or $100), to assess whether a threat actor is applying a transaction test.

In a case where the identifier is a numerical identifier, the numerical identifier of each deficient synthetic user identity passes only some of the authentication tests corresponding to the predefined structure. For example, the numerical identifier may have the right number of digits but not be Luhn valid. The set of deficient synthetic user identities may comprise a mixture of deficient synthetic user identities for which the respective numerical identifiers pass different ones of the authentication tests.

In embodiments where the identifier is not a numerical identifier, the identifier for each pseudo-genuine synthetic user identity passes all authentication tests associated with the identifier.

Where the identifier is an e-mail address, it may be non-functional or functional; functional e-mail addresses may be created for the synthetic user identities by hosting e-mail servers for one or more domains, or by arrangement with one or more established e-mail providers for added realism. Non-functional e-mail addresses may be structurally valid, that is, the e-mail address has a valid format to be an e-mail address, or may be structurally deficient (e.g. missing the “@” symbol). For example, “example@example.com” is a valid e-mail address format, but “example*example.com” is not valid since there is no “@” symbol. There are two authentication tests for an e-mail address as an identifier. The first is whether the e-mail address is structurally valid or structurally deficient. The second is a response test—whether an e-mail message sent to that e-mail address elicits a response, such as a reply, a delivery receipt, or clicking on a link. Some threat actors will send an e-mail that is not designed to redirect someone to a phishing website to capture their data, but merely to test whether the e-mail address is monitored, for example an e-mail purporting to come from a courier company and that contains a fake “track your package” link. The link may redirect to a benign web page that merely confirms the identity of the e-mail address that responded (thus potentially evading anti-phishing or anti-malware software). A pseudo-genuine synthetic user identity may be created by setting up a genuine e-mail address and monitoring that e-mail address (preferably on a dedicated computer system suitably isolated from any other computer system) using either a programmed agent or one or more human monitors to respond to such test e-mails. Thus, if a threat actor were to send an e-mail message to an e-mail address for a pseudo-genuine synthetic user identity, the message would elicit a response.

In embodiments where the identifier is not a numerical identifier, the identifier for each deficient synthetic user identity passes only some of the authentication tests associated with the identifier. Where the identifier is an e-mail address, it may pass the structural test but not the response test.

In some embodiments, the pool of synthetic user identities comprises only the set of pseudo-genuine synthetic user identities, and in other embodiments the pool of synthetic user identities comprises only the set of deficient synthetic user identities. Preferably, the pool of synthetic user identities comprises both pseudo-genuine synthetic user identities and deficient synthetic user identities.

As noted above, the user credentials preferably include other credentials besides the identifier. In preferred embodiments, the other credentials include at least a password. In some embodiments, the identifier may also serve as a user name, so that the identifier and the password form a complete set of user credentials. The passwords may be obviously fictitious passwords, such as “Password” or “IKnowYouArePhishingMe” or “YouCantPhishMeHacker”, or may be realistic passwords. Realistic passwords may be those that might be generated by a human individual while meeting basic password strength requirements, such as minimum length, use of both upper-case and lower-case letters, and use of numbers and/or special characters, or which are generated by an actual password generator. In some embodiments, the user credentials may further comprise password verification questions (PVQs) and answers. The use of PVQs and answers as part of the user credentials can enable determination of whether a threat actor is set up to bypass a PVQ challenge that may be triggered by a login using the correct username/password combination but with previously unseen characteristics such as geo-location, browser type, etc. Preferably, an institution executing the method 400 will verify that none of the user names, e-mail addresses, passwords or PVQ answers for the synthetic user identities correspond to any actual clients of that institution, even by accident.

In preferred embodiments, each of the synthetic user identities (whether pseudo-genuine synthetic user identities or deficient synthetic user identities) further comprises a set of user fingerprint characteristics. Examples of user fingerprint characteristics include screen resolution, device profile, browser type, Internet Service Provider (ISP), and network (geographic location) among a wide range of other fingerprint characteristics. The geographic location in the fingerprint characteristics may conform to the physical address in the user credentials, or may be non-conforming.

After generating the pool of synthetic user identities at step 402, at step 404, the method 400 uses the user credentials to seed a plurality of the synthetic user identities from the pool into a threat actor computer system hosting a phishing website impersonating a genuine login page. In an embodiment where the pool of synthetic user identities comprises both pseudo-genuine synthetic user identities and deficient synthetic user identities, the synthetic user identities from the pool that are seeded into the threat actor computer system hosting the phishing website preferably comprise both pseudo-genuine synthetic user identities and deficient synthetic user identities. The synthetic user identities from the pool that are seeded into the threat actor computer system hosting a particular phishing website may be all or a subset of the set of pseudo-genuine synthetic user identities and all or a subset of the set of deficient synthetic user identities. Thus, in a preferred embodiment, synthetic user identities with different types of user credentials can be seeded into a threat actor computer system hosting a phishing website. Preferably each synthetic user identity is seeded only once, that is, a synthetic user identity is preferably only seeded into a single phishing website (as a single threat actor computer system may host multiple phishing websites). An automated interaction management agent (described further below) may be used to seed the synthetic user identities from the pool into the threat actor computer system hosting the phishing website, and this interaction management agent can present the user fingerprint characteristics to the phishing website. In a preferred embodiment, synthetic user identities are seeded over time, e.g. over the lifespan of a phishing site. Preferably, the interaction management agent will randomize the fingerprint characteristics, so that the seeding of the threat actor computer system hosting the phishing website will appear to be real traffic and be less likely to be detected by the threat actor.

In preferred embodiments, the interaction management agent uses session randomization for fingerprint characteristics, including IP addresses and user agents (the HTTP string identifying the browser, version, number and host operating system), and may be configured to bypass bot detection controls implemented by the threat actor computer system hosting the phishing website. The interaction management agent may intentionally access multiple pages of the phishing website in order to simulate a human visitor. As described further below, in addition to managing seeding operations, the interaction management agent may also coordinate covert digital reconnaissance of a threat actor computer system hosting the phishing website.

The objective is for the automated interaction management agent to create realistic interactions with the threat actor computer system hosting the phishing website, so that neither the interactions nor the seeded synthetic user identities are flagged by the threat actor as being suspicious. As such, the interaction management agent may vary the methodology used to perform interactions and seed the synthetic user identities, and may deploy misdirection. For example, where the pool of synthetic user identities comprises both pseudo-genuine synthetic user identities and deficient synthetic user identities, the interaction management agent may seed a plurality of synthetic user identities (e.g. deficient synthetic user identities) from a single IP address after previously seeding a plurality of synthetic user identities from a range of IP addresses (e.g. by creating a new proxy session for each submission). The threat actor may perceive that the later seeding from the single IP address is an intentional disruption effort, indicating that the phishing website has been discovered by a “white hat” entity. This may increase the threat actor's confidence that the synthetic user identities that were seeded earlier (before the seeding from the single IP address) are genuine victims, as the threat actor may perceive that these earlier submissions were received before the phishing website was “discovered”. In addition, whether or not the threat actor blocks the single IP address can support making behavioural inferences about the threat actor.

In some embodiments, the interaction management agent may adopt a “follow-the-sun” approach, where there are more engagements with the threat actor computer system hosting the phishing website during times of day that would be daytime hours according to geographical aspects of the fingerprint characteristics (e.g. physical address/postal code/zip code or IP geolocation and time of day). For example, if the geographical aspects of the fingerprint characteristics indicate a synthetic user identity in Florida, engagements may be targeted for daytime/early evening in Florida. Further, known time-distributions of phishing victim compromises can be applied to the seeding schedules. In one hypothetical example, if it were known that phishing victims commonly submit their credentials to the threat actor computer systems hosting phishing websites in response to checking e-mails in the morning after they wake up (e.g. between 6:00 and 8:00 a.m.), seeding may be heavier during that period for the relevant time zone, with lighter seeding overnight.

In preferred embodiments, a threshold will be defined to limit the number of synthetic user identities that can be seeded into a threat actor computer system hosting a phishing website, both over a given period and in total; the objective is to avoid impacting the threat actor's infrastructure (which could alert the threat actor), and also avoid disrupting legitimate services that may share infrastructure with the phishing operation, but still seed enough synthetic user identities to achieve the desired objective.

If the objective of the method 400 is to disrupt phishing operations by diluting the credentials of real victims, the method 400 may end after seeding the synthetic user identities at step 404. However, if the objective of the method 400 is to disrupt phishing operations by profiling threat actors and identifying operational security failures that can be remediated, the method 400 may continue to step 406.

After generating the pool of synthetic identities at step 402 and seeding the synthetic identities at step 404, the method 400 may proceed to step 406. At step 406, the method 400 monitors, at a server system hosting the genuine login page, for login attempts for which the synthetic user identities are used for the login attempts. Such login attempts may be an example of a threat actor signal that may be collected as part of a system and method described further below. Of note, where a significant number of login attempts for the synthetic user identities are detected, this may be an indication that a threat actor is seeking to exploit captured credentials, so that additional security steps can be taken to protect genuine victims who may have entered their credentials into the threat actor computer system hosting the phishing website into which the synthetic user identities were seeded. Such steps may be taken even if the victim is unaware that his/her credentials have been compromised.

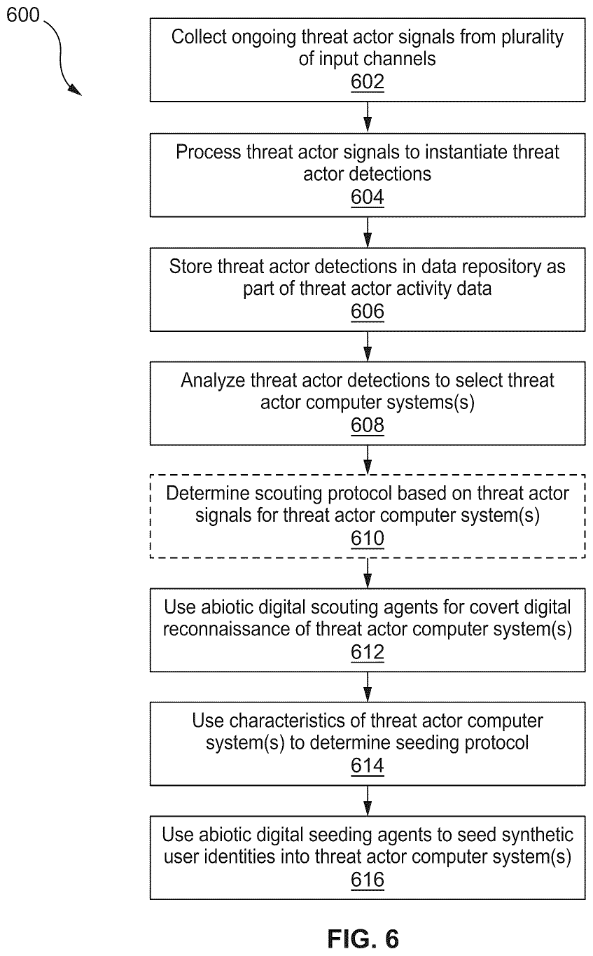

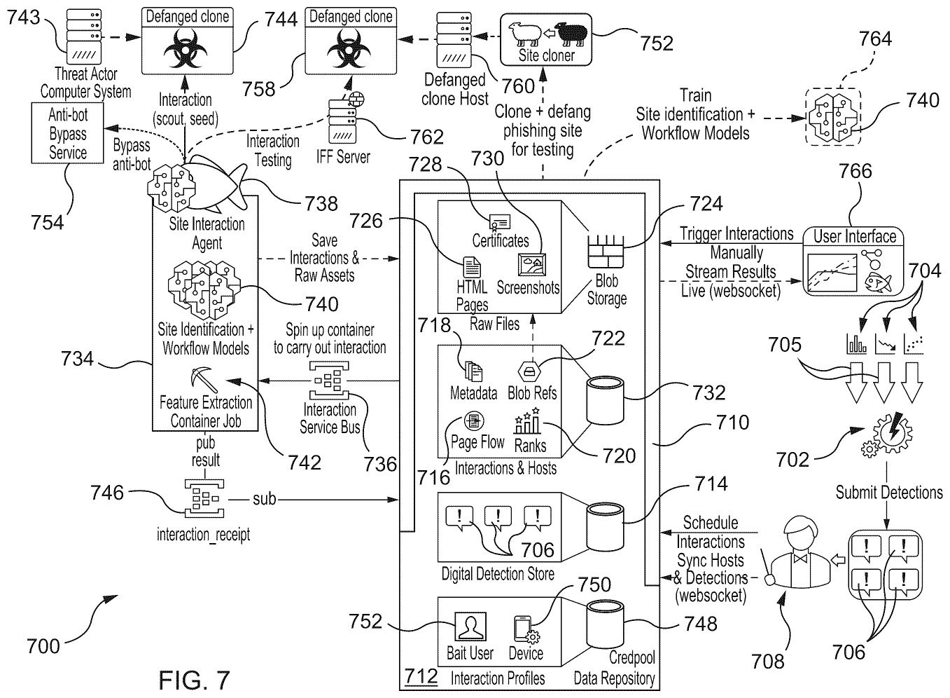

At step 408, the method 400 compares the synthetic user identities that are used for the login attempts to an entire set of the synthetic user identities that were seeded into the threat actor computer system hosting the phishing website, and at step 410 the method 400 determines, from the comparison at step 408, behaviour characteristics of a threat actor associated with the phishing website. A threat actor's behaviour over time can be monitored, and indicators of an attack and/or a threat actor signature may be obtained and fed into detection/prevention models. An illustrative, non-limiting, non-exhaustive example of such a system and method is described further below in the context of FIGS. 6 and 7.

The determination of the behaviour characteristics of the threat actor at step 410 may take a variety of forms. For example, where the pool of synthetic user identities comprises both pseudo-genuine synthetic user identities and deficient synthetic user identities, the determination at step 410 may determine whether the threat actor was able to identify and discard some or all of the deficient synthetic user identities. If the threat actor was able to identify and discard only some of the deficient synthetic user identities, the characteristics of the deficient synthetic user identities that the threat actor was able to identify and discard may be used to determine aspects of the threat actor's behaviour characteristics and/or capabilities.

Where the synthetic user identities include user fingerprint characteristics, the comparison at step 408 may include comparing the user fingerprint characteristics of the synthetic user identities that are used for the login attempts to the user fingerprint characteristics of the entire set of the synthetic user identities that were seeded into the threat actor computer system hosting the phishing website. Then, the determination at step 410 can take this additional information into account. It may be determined that the synthetic user identities that are used for the login attempts have a common or predominant fingerprint characteristic, or a fingerprint characteristic that is generally absent. This information may be used to characterize aspects of the threat actor behavior and/or capability. For example, where the user credentials that are seeded include an address (or at least a postal code or zip code) and the fingerprint characteristics include geographic location, it may be possible to determine whether a threat actor is distinguishing between those synthetic user identities where the geographic location in the fingerprint characteristics conforms to the physical address in the user credentials, and those where the geographical location does not so conform (e.g. an IP address indicating Cincinnati, Ohio but a zip code indicating Fort Stockton, Texas).

Reference is now made to FIG. 5, which is an illustrative, non-limiting diagram showing a schematic architecture overview for a computer-implemented system 500 for obstructing phishing. In the illustrated embodiment, the system 500 comprises an on-premises environment 502 (e.g. data center 106), a cloud hosting environment 504, and a proxy network 506. The division between the on-premises environment 502 and the cloud hosting environment 504 is merely illustrative, and not limiting. The cloud hosting environment 504 and the proxy network 506 cooperate to form an interaction infrastructure 508, which can be used for covert digital reconnaissance as described below, and also for seeding synthetic user identities.

Within the on-premises environment 502, a credential generator 510 generates a pool of synthetic user identities, each including an identifier 512 and a preferably a password. Preferably the identifier 512 is a numerical identifier 512 having the same number of digits as a transaction card (e.g. credit or debit card). The pool of synthetic user identities may comprise pseudo-genuine synthetic user identities and/or deficient synthetic user identities. The credential generator 510 may, for example, use a random number generator subject to (at least for pseudo-genuine synthetic user identities) constraints such as the transaction card format of the issuing entity and Luhn validity. One or more of the constraints may be inverted for deficient synthetic identities (e.g. these may be forced to be Luhn invalid). At least for pseudo-genuine synthetic user identities, the credential generator 510 checks an issued credentials database 514 to validate that the generated numerical identifiers 512 are not already in use; any generated credentials that are already in use are discarded. Optionally, the credential generator 510 may generate additional aspects of the synthetic user identities, such as one or more of a password, an expiry date, a user name, a personal name, a card type (e.g. an identification of the issuing bank or credit card brand), a Card Verification Value (CVV) number, an e-mail address, and a physical address (which may be a complete address or only a zip code or postal code), among others. The credential generator 510 saves the synthetic user identities to an analytics database 516. A new pool of synthetic user identities may be generated periodically (e.g. daily).

The synthetic user identities are periodically (e.g. daily) pushed from the on-premises environment 502 to the cloud hosting environment 504. The cloud hosting environment 504 hosts a plurality of suitably configured virtual machines (VMs). An application programming interface (API) gateway 518 provides access to the cloud hosting environment 504, which supports a job scheduler 520 as well as an interaction management agent 522 which executes automated or “robotic” operations for a targeted phishing website 532 according to specified parameters, and may generate at least some of the fingerprint characteristics. The interaction management agent 522 controls a plurality of individual agents to perform covert digital reconnaissance as described further below, and to carry out individual seeding operations. Some of the parameters and/or fingerprint characteristics may be generated in advance during synthetic profile generation by the credential generator 510 and are simply assigned to the individual agent when it carries out its seeding operation. The individual agent is programmed to conform to the characteristics at runtime, i.e. presenting a given user agent string to the threat actor computer system hosting the phishing website 532 via a request header. Other fingerprint characteristics are allocated dynamically at runtime (i.e. IP address of an established proxy session). The cloud hosting environment 504 also hosts a credential pool 524, which is a database that stores the synthetic user identities. The interaction management agent 522 will reserve profiles from the credential pool 524, telling the credential pool 524 what characteristics/parameters to present, before undertaking seeding operations for a targeted phishing website 532.

The targeted phishing website 532 can be identified by any suitable technique. These can include specialized vendors, as well as external repositories. One non-limiting, non-exhaustive example of such a repository is “PhishTank” (phishtank.com, phishtank.com and phishtank.org), which is a clearinghouse website where suspected phishing websites can be reported. The use of external repositories may enhance the ability of an institution's threat hunters to identify phishing websites to be targeted for seeding, since users can report suspicious websites to such repositories. Web agents can also be used to identify potential phishing websites. In some embodiments, as described further below, ongoing threat actor signals may be automatically collected from a plurality of input channels and used to instantiate threat actor detections, which can be analyzed to select the targeted phishing website 532 and thereby target the associated threat actor computer system.

The interaction management agent 522 communicates 526 with the proxy network 506. The proxy network 506 is used to provide an appropriate IP address/geolocation for the seeding. For example, where a synthetic user identity includes address or zip code/postal code information, the interaction management agent 522 may instruct the proxy network 506 to use a corresponding IP address/geolocation. Alternatively, the interaction management agent 522 may instruct the proxy network 506 to use a non-corresponding IP address/geolocation if it is intended to evaluate whether the threat actor(s) will act upon a mismatch between address or zip code/postal code and IP address/geolocation. Thus, the interaction management agent 522 presents the numerical identifier 512 and any other user credentials, including any fingerprint characteristics it has generated, to the threat actor computer system hosting the phishing website 532 via the proxy network 506. The interaction management agent 522 communicates any fingerprint characteristics that it has generated, along with the timestamp and any IP address/geolocation from the proxy network 506, back to the analytics database 516 where they are associated with the respective synthetic user identities. This will facilitate detection and analytics.

Thus, as shown schematically in FIG. 5, the interaction infrastructure 508 uses the user credentials to seed a plurality of the synthetic user identities 530 into a threat actor computer system hosting a phishing website 532, which has also captured the credentials associated with a genuine user identity 534 of a real human victim. In the illustrated embodiments, the synthetic user identities 530 include both pseudo-genuine synthetic user identities 530A, 530B, 530C and a deficient synthetic user identity 530D which is not Luhn valid. The use of only four synthetic user identities 530 is merely for simplicity of illustration and in practice there would be many more synthetic user identities 530 seeded into the threat actor computer system hosting the phishing website 532.

FIG. 5 represents a common situation in which there is more than one threat actor, and more particularly where the threat actor who operates the threat actor computer system hosting the phishing website 532 (phishing threat actor 536) is different from the threat actor (impersonator threat actor 538) who exploits the credentials captured by the threat actor computer system hosting the phishing website 532. In the illustrated embodiment, the phishing threat actor 536 sells 540 the captured credentials to the impersonator threat actor 538, for example on the Dark Web. FIG. 5 also shows that the phishing threat actor 536 has filtered out the deficient synthetic user identity 530D; more sophisticated threat actors will apply a Luhn validity test to the captured credentials and eliminate those that do not pass the Luhn validity test.

Not all of the user credentials that make up the synthetic user identities 530 are necessarily requested/captured by the threat actor computer system hosting the phishing website 532. For example, the phishing website may request a user name, e-mail address, card number and password, but not an address.

Having acquired a set of captured credentials, the impersonator threat actor 538 sets out to exploit them, and may use automation 542 if there is a large volume of credentials to be so exploited. Thus, the impersonator threat actor 538 uses the captured pseudo-genuine synthetic user identities 530A, 530B, 530C (the deficient synthetic user identity 530D having been filtered out) for login attempts at the genuine login page 544. In addition, the genuine user identity 534 is also used for a login attempt at the genuine login page 544. Where seeding is successful, the captured pseudo-genuine synthetic user identities 530A, 530B, 530C may predominate the login attempts, which may provide an indication (threat actor signal) that a threat actor is seeking to exploit captured credentials, so that additional security steps can be taken to protect the victim associated with the genuine user identity 534. Moreover, by saturating the threat actor computer system hosting the phishing website 532 with pseudo-genuine synthetic user identities 530A, 530B, 530C for which the numeric identifiers are Luhn valid and therefore cannot be excluded based Luhn validity, threat actor activities may be disrupted or slowed. For example, a particularly cautious phishing threat actor 536 may decommission the phishing website 532 after capturing a predetermined number of Luhn valid numeric identifiers to avoid detection. If some or many of these are pseudo-genuine synthetic user identities 530A, 530B, 530C, the number of genuine users whose credentials are compromised may be reduced.

At the on-premises environment 502, the server system hosting the genuine login page 544 monitors login attempts for those where the synthetic user identities 530 are used for the login attempts. Application logs 546 are sent to network traffic monitoring and analytics applications 548 to capture the relevant data, which can then be stored in the analytics database 516. In one embodiment, the network traffic monitoring and analytics applications 548 may comprise an “ELK stack” (also referred to as an “Elastic stack”) comprising the Elasticsearch application, the Logstash application and the Kibana application. One implementation of the ELK stack (https://www.elastic.co/elastic-stack) is available from Elastic N.V. having a registered office at Keizersgracht 281, 1016 ED Amsterdam (European headquarters), 88 Kearny St., Floor 19, San Francisco, CA 94108 (United States). The Elasticsearch application is a RESTful data search and analytics program (https://www.elastic.co/elasticsearch). The Logstash application (https://www.elastic.co/logstash) is an open-source data ingestion program and the Kibana application (https://www.elastic.co/kibana) is a data visualization program. The Logstash application ingests the application logs 546 from the genuine login page 544, applies appropriate transformations and sends the data onward, the Elasticsearch application can perform suitable searches upon the ingested data, and the Kibana application supports visualizations of the data. Use of the ELK stack for appropriate monitoring is within the capability of one of ordinary skill in the art, now informed by the present disclosure. The ELK stack is merely an illustrative example and is not limiting or exhaustive, and any suitable network traffic monitoring and analytics applications may be used.

After processing the application logs 546, the entire set of synthetic user identities 530A, 530B, 530C, 530D that were seeded, and the data from the login attempts for which the synthetic user identities 530A, 530B, 530C were used, are both stored in the analytics database 516. Threat actor behaviour characteristic analytics 550 can then be performed by comparing the synthetic user identities 530A, 530B, 530C that are used for the login attempts to the entire set of the synthetic user identities 530A, 530B, 530C, 530D that were seeded into the threat actor computer system hosting the phishing website 532. The threat actor behaviour characteristic analytics 550 can determine, from the comparison, behaviour characteristics of a threat actor 536, 538 associated with the phishing website 532. In the trivial case shown in FIG. 5 merely for purposes of illustration, the comparison would show that one of the threat actors 536, 538 was able to identify and exclude the deficient synthetic user identity 530D that was not Luhn valid. In practice, the threat actor behaviour characteristic analytics 550 can be much more sophisticated, and may include user behaviour analytics (UBA) 552, correlation-based detections 554, threat actor insights 556 and/or A/B testing 558.

UBA 552 generally comprises collection and analysis of data relating to user behaviour to establish a baseline, whereby departures from the baseline can be flagged as suspicious. One illustrative, non-limiting, non-exhaustive example of a UBA tool is https://www.elastic.co/what-is/user-behavior-analytics available from the above-noted Elastic N.V. Any suitable UBA tool may be used.

One example of a correlation-based detection 554 is identifying a real user who has been compromised by a phishing website by correlating the login logs for the synthetic user identities (known true-positive phishing logins) with other user login logs that have the same fingerprints. Another example of a correlation-based detection 554 might be finding all user logins coming from the same IP address and using the same user agent string (an HTTP header that contains details about the operating system, browser, version, etc. of the system requesting the website in question) as a detected bait credential (optionally within a particular time window, e.g. 30 minutes).

Examples of threat actor insights 556 include whether a threat actor appears to know about Luhn validity checks, whether a threat actor is operating multiple phishing websites, and whether multiple parties are involved in the operation (e.g. buying/reselling).

Examples of A/B testing 558 include seeding synthetic user identities with different characteristics and measuring which synthetic user identities result in the threat actor taking action. For example, to determine whether a threat actor is aware of Luhn validity checks, a threat actor computer system hosting a phishing website may be seeded with a plurality of synthetic user identities for which half are pseudo-genuine synthetic user identities that are Luhn valid, and half are deficient synthetic user identities that are Luhn invalid, and the threat actor's response can be measured. Similar methodology could be used to improve robotic navigation and anti-bot bypasses by testing different network proxy and VPN solutions to avoid network block-lists.

The threat actor behaviour characteristic analytics 550 in conjunction with the use of the synthetic user identities 530 may allow for modeling the behaviour of particular threat actors, clustering networks of threat actors (e.g. threat actors 536, 538 working in concert) and affiliated infrastructure, and extracting actionable indicators of compromise (IOCs). Each of these can then be used for hardening and security enhancement. One or more threat actors may be profiled by correlating behaviour that is common to multiple phishing sites to a single threat actor or a single instance of “Phishing as a Service” (abbreviated “PHaaS”).

More generally, the combination of the credential generator 510, the interaction infrastructure 508 and the threat actor behaviour characteristic analytics 550 enable a computer-implemented method for remediation targeting a threat actor computer system (e.g. hosting a phishing website 532).

Reference is now made to FIG. 6, which is a flow chart showing an illustrative computer-implemented method 600 for remediation targeting a threat actor computer system. At step 602, the method 600 automatically collects ongoing threat actor signals from a plurality of input channels. The threat actor signals may take a variety of forms, including malicious website URLs, detected threat actor activity such as resource requests (e.g. where an unknown or suspicious server requests resources from a legitimate website), compromised genuine user credentials, user credentials from synthetic user identities, user or other third-party reports, and compromised code beacons. Compromised code beacons are described in United States Patent Application Publication No. US 2024-0179159 A1, the teachings of which are hereby incorporated by reference. An illustrative implementation of detection of threat actor signals by use of compromised code beacons is described further below.

The input channels for the threat actor signals may comprise, for example, compromised code beacon detectors, feeds from one or more phishing site detection products, one or more anti-phishing software products, one or more abuse feeds, and login attempts. A non-limiting and non-exhaustive list of phishing site detection products includes the URLScan.io service (https://urlscan.io/) offered and operated by urlscan GmbH, a German limited-liability company, incorporated in Aachen, Germany (HRB 23462) and having an address at Kuhlweg 6b, 52074 Aachen, Germany and the VirusTotal service (https://www.virustotal.com/gui/home/url) offered by Google LLC, having an address at 1600 Amphitheatre Parkway, Mountain View, California 94043 U.S.A. and related entities. A non-limiting, non-exhaustive example of an anti-phishing software product is the Fortra Brand Protection (formerly PhishLabs) software offered by Fortra LLC of 11095 Viking Drive, Suite 100, Eden Prairie, MN 55344 U.S.A. An abuse feed may be any suitable reporting mechanism by which individuals can report suspected phishing attempts to the proprietor of the legitimate website. This could be via a dedicated e-mail reporting address, for example. In some embodiments, an automated crawler may observe social media to identify threat actor signals (e.g. an account purporting to belong to the proprietor of the legitimate website, or user reports of phishing posted to social media). Login attempts may be from genuine user identities that are known to be compromised (e.g. where an individual has previously reported that their user credentials had been phished and those user credentials were frozen) or may be synthetic user login attempts from synthetic user identities that were seeded into a threat actor computer system in the manner described above. In the latter case, the threat actor signals may be obtained by monitoring, at a server system hosting the genuine login page, for login attempts for which the synthetic user identities are used. For example, web server logs can store details of connections such as source IP address, user agent string, and more. As well, in many enterprise environments, sophisticated user identification or ‘fingerprinting’ technologies are deployed to track users and devices between sessions. Another example of an input channel is a clearinghouse website where suspected phishing websites can be reported, such as “PhishTank” (phishtank.com and phishtank.org). Thus, the threat actor signals may comprise raw data that is collected by a system implementing the method 600 from a variety of input channels, at least some of which may be unrelated to the system implementing the method 600.

At step 604, the method 600 automatically processes the threat actor signals to instantiate threat actor detections from the threat actor signals. The threat actor detections are instances where one or more threat actor signals sufficiently implicate the activity of a threat actor (which may include a group of threat actors acting in concert). A threat actor detection ties a detected event to a particular threat actor (whose actual identity may not be known, but may be identified by, for example, a URL or other identifier). Thus, the threat actor signals may be phishing signals, and the threat actor detections may be phishing detections. In some instances, a single threat actor signal may be sufficient to implicate the activity of a threat actor and therefore to instantiate a threat actor detection. For example, a single e-mail report from a compromised user may be sufficient. In other instances, multiple threat actor signals may be required to implicate the activity of a threat actor sufficiently to instantiate a threat actor detection. For example, a low-confidence report from a third-party phishing detection product may not be sufficient, in and of itself, to instantiate a threat actor detection, but such a report, coupled with a log showing that images from the legitimate website were fetched by the same URL, may be sufficient to instantiate a threat actor detection. Thus, the threat actor signals may comprise suspected malicious website URLs and suspicious resource requests. There is no hard-and-fast rule as to the number or quality of threat actor signals associated with a particular URL that would be required to implicate the activity of a threat actor and therefore instantiate a threat actor detection; this is a function of the nature of available data and the desired sensitivity of the system. Preferably, a login attempt using credentials known to be compromised, or using credentials associated with a synthetic user identity, will be sufficient to instantiate a threat actor detection. For example, a previously detected threat actor computer system may have been seeded with synthetic user identities, and a subsequent login attempt using one of those seeded synthetic user identities may indicate that the synthetic user identity has been passed to a different threat actor, warranting further investigation. Or the credentials associated with a genuine user identity known to have been compromised may be used in a login attempt (i.e. so-called “peeking”). Thus, in a preferred embodiment, the threat actor signals comprise compromised credential detections and the threat actor detections are instantiated from the compromised credential detections (e.g. synthetic user identities that were seeded and/or credentials associated with genuine user identities where those credentials appear to have been compromised).

In a preferred embodiment, the threat actor detections are represented as generalized models with reusable enrichment processes and including bespoke fields for each of a plurality of detection types using hierarchical schemas. For example, the Pydantic data validation library for Python (https://docs.pydantic.dev/latest/), which is incorporated herein by reference, may be used. Then, at step 606, the method 600 stores the threat actor detections in a data repository as part of threat actor activity data maintained within the data repository. In preferred embodiments, the threat actor activity data in the data repository is asynchronously enriched with additional data. The additional data may comprise, for example, one or more of IP lookup metadata, compromised user type, and validity. For example, enrichment with IP lookup metadata may comprise automatically examining the source IP of the detection (e.g. a login attempt) and determining that the threat actor signed in to the stolen account using an IP address that has been determined to be part of a proxy network or commercial VPN service, thus confirming that the threat actor is taking steps to hide his/her origin point. Validity enrichment processes might take the card number identified in association with the detection and validate whether the card number corresponds to a real, existing user or to a synthetic user identity.

At step 608, the method automatically analyzes the threat actor detections in the data repository to select at least one threat actor computer system. A “threat actor computer system” is a computer system that is operated by a threat actor to engage in phishing activity such as hosting a phishing website, or operating a reverse proxy server to hide the ultimate location of a phishing website or to enable live interaction with the victim on the phishing website. Although a “threat actor computer system” may be owned by the threat actor, it need not be (e.g. the computer system operated by the threat actor may be leased or hijacked by the threat actor). A “threat actor computer system” may be a plurality of individual computer systems networked together, whether co-located or geographically separated.

Selection of the threat actor computer system(s) at step 608 may be based on a variety of factors arising from the analysis. Some non-limiting, non-exhaustive examples of such analysis include considering the source of the detection (is it from a source that gives early warning of phishing sites or is it from a source that would provide a detection only after victimization has occurred), and examining historic detections and interactions to see whether the detection corresponds to a threat actor computer system from a previous detection. Another factor that may arise from the analysis is volume of activity. A high volume of activity may indicate that the phishing website associated with a particular threat actor computer system is attracting potential victims, making it a higher priority for intervention. For example, using the compromised code beacon detection technology described in U.S. Patent Application Publication No. 2024-0179159 A1 and further below, the volume of detected compromised code beacons may function as a proxy for the volume of phishing activity. Another potential factor is evidence or signals indicating whether the phishing campaign has been widely distributed yet (e.g. reports from third party tracking services, or reports from clients showing e-mails and/or SMS messages) containing the domain name associated with the phishing website). Interacting with a phishing website that is not yet widely known might alert the threat actor that their phishing websites can be detected ahead of a campaign launch (e.g. phishing e-mail campaign, SMS phishing or “smishing” campaign) compromising operational security.

At optional step 610, the method 600 automatically determines a scouting protocol based on the respective threat actor signals for the threat actor computer system(s). The scouting protocol used at optional step 610 (if present), will be used by abiotic digital scouting agents at step 612. In other embodiments, a default scouting protocol may be used, in which case optional step 610 may be omitted.

At step 612, the method 600 automatically uses abiotic digital scouting agents to perform covert digital reconnaissance of the threat actor computer system(s) to identify respective characteristics of the threat actor computer system(s). The covert digital reconnaissance may capture, for example, HTML pages, certificates and screenshots of phishing websites hosted by the threat actor computer system(s) and may probe the phishing websites to identify countermeasures implemented by the threat actor computer system(s), such as anti-bot features like CAPTCHA (“Completely Automated Public Turing test to tell Computers and Humans Apart”) and reCAPTCHA (https://developers.google.com/recaptcha) among others. The abiotic digital scouting agents autonomously interact with the threat actor computer system(s) and observe characteristics of the threat actor computer system(s); the characteristics of the threat actor computer system(s) are processed into the data repository as part of the threat actor activity data. Some non-limiting, non-exhaustive examples of characteristics of the threat actor computer system(s) include IP address, server hosting locations, use of anti-bot features, use of visitor fingerprinting software, specific coding techniques or identifiable characteristics of the phishing website source code (e.g. use of a known phishing kit).

The abiotic digital scouting agents communicate with the threat actor computer system(s) through one or more computer networks. The abiotic digital scouting agents may be coordinated by the interaction management agent 522 described in the context of FIG. 5; the abiotic digital scouting agents may be specific instantiations of common interaction agent program code that is also used to carry out the individual seeding operations (step 616). The abiotic digital scouting agents perform the covert digital reconnaissance according to a scouting protocol, which may be the scouting protocol determined at optional step 610, when present, or a default scouting protocol. The digital reconnaissance is covert in that it is designed to obscure the true source of the abiotic digital scouting agents and avoid alerting the threat actor operating the respective threat actor computer system; the abiotic digital scouting agents may use similar techniques to those described above for obfuscation of the true origin of the abiotic digital scouting agents. The abiotic digital scouting agents may assess whether the phishing website is reachable at all (e.g. the phishing website may have already been taken down) or is reachable only from particular geographic location(s) or jurisdictions. To carry out the latter assessment, the abiotic digital scouting agents may be configured by the proxy network 506 (FIG. 5) to present a range of different IP address/geolocation information profiles.

At step 614, the method 600 automatically uses the characteristics of the threat actor computer system(s) that were identified by the abiotic digital scouting agents at step 612 to determine a seeding protocol. The seeding protocol may specify, for example, numbers and characteristics of synthetic user identities, fingerprint characteristics, page interaction procedures, and timing of interactions. An initial check may consider whether the phishing website is still reachable, as the time delta between scouting and deciding to seed could be such that the phishing website has already been taken down. Accordingly, there may be a smaller, limited deployment of abiotic digital scouting agents.

A seeding protocol may consider one or more of the following non-limiting, non-exhaustive, illustrative variables relevant to the seeding process:
what countermeasures are being deployed by the threat actor computer system(s) hosting the phishing website(s), and what counter-countermeasures and associated resources are required (e.g. anti-bot features may require anti-bot bypass);
whether the phishing website is associated with an active phishing campaign;
if active, what is the observed velocity (rate at which victims are “hooked”);
the location(s) and/or jurisdiction(s) in which victims are located.

For example, if a phishing website is known to be live, but a phishing lure (e.g. e-mail or text message campaign) targeting potential victims has yet to be deployed, seeding the associated threat actor computer system(s) risks revealing prior knowledge of the phishing website, which may provoke the threat actor to investigate further. In such circumstances, the seeding protocol may be a “null” seeding protocol (i.e. do not seed). Alternately, if the phishing website has been reported by third party intelligence source, this indicates an active phishing campaign so that seeding would not disclose any prior knowledge and thus seeding may proceed. A higher velocity would suggest a more aggressive seeding protocol, and the seeding protocol may direct the proxy network 506 (FIG. 5) to provide appropriate IP address/geolocation information consistent with the location(s) and/or jurisdiction(s) in which victims are located. The foregoing are merely illustrative examples. In some embodiments, the seeding protocol may be determined by a trained machine learning engine that uses the characteristics of the threat actor computer system(s) as inputs and generates a seeding protocol as an output.

At step 616, the method 600 automatically uses abiotic digital seeding agents to seed a plurality of synthetic user identities into the threat actor computer system(s) according to the seeding protocol determined at step 614. The abiotic digital seeding agents may be coordinated by the interaction management agent 522 described in the context of FIG. 5; the abiotic digital seeding agents may be specific instantiations of common interaction agent program code that is also used to carry out the covert digital reconnaissance (step 612). The abiotic digital seeding agents may seed the synthetic user identities into the threat actor computer system(s) in the manner described above in the context of FIG. 5, for example.

After step 616, the method 600 returns to step 602 and continues automatically collecting the ongoing threat actor signals from the input channels; the threat actor signals collected at step 602 may include login attempts and other signals resulting from the seeding at step 616. Of note, while FIG. 6 shows step 602 of automatically collecting the ongoing threat actor signals from the input channels as a discrete step for simplicity of illustration, in practice step 602 is ongoing and continues throughout steps 604 through 616 as well.

Reference is now made to FIG. 7, which is an illustrative diagram showing a schematic architecture overview for a computer-implemented system 700 for remediation targeting a threat actor computer system, and which may be used in implementing the method 600 shown in FIG. 6.

Intake logic 702 automatically collects the ongoing threat actor signals 704 from a plurality of input channels 705, as described above in the context of step 602 of the method 600 in FIG. 6. Thus, the threat actor signals 704 may comprise one or more of malicious website URLs, detected threat actor activity, compromised code beacons and compromised user credentials. The input channels 705 comprise any two or more of (a) at least one phishing-site detection product, (b) at least one anti-phishing software product, (c) at least one abuse feed, (d) at least one login attempt. The input channels 705 may further comprise a compromised code beacon detector. For example, where the threat actor signals 704 include compromised code beacons (as described further below), the intake logic 702 may instantiate a threat actor detection 706 by extracting the domain of the phishing host server that triggered transmission of a compromised code beacon. The intake logic 702 may, for example, perform deduplication, cross referencing of whitelisted domains/URLs, and basic digital hygiene and sanitization of input data.

The intake logic 702 also automatically processes the threat actor signals 704 to instantiate threat actor detections 706 from the threat actor signals 704, as described above in the context of step 604 of the method 600 in FIG. 6.

An orchestrator 708 engages with an application programming interface (API) 710 for a data repository 712 to store the threat actor detections 706 in the data repository 712 as part of threat actor activity data maintained within the data repository 712. The threat actor detections 706 are maintained in detection store 714 in the data repository 712. Other threat actor activity data maintained within the data repository 712 includes page flow information 716 for phishing websites, metadata 718 for phishing websites, rankings and heuristics 720 for phishing websites, and blob references 722 linking to locations in blob storage 724, which may contain HTML pages 726 for phishing websites, certificates 728 such as TLS certificates used by the phishing websites to offer HTTPS connectivity, and screenshots 730 for phishing websites, intermediary landing pages and/or lure pages such as financial transaction sites. The page flow information 716 comprises data pertaining to navigation of a website that is revealed at the network layer, such as which page redirects to which page, which page is loaded in response to user interaction such as clicking a button, etc. The metadata 718 for the phishing websites comprises details about the phishing websites such as the URL, IP address, number of visits, use of anti-bot features, etc. The rankings and heuristics 720 for the phishing websites may comprise or be based upon the number of visits from known victims, page loading details, and other relevant information. The page flow information 716, metadata 718, rankings and heuristics 720 and blob references 722 are retained in an interaction and hosts store 732 in the data repository 712. In some embodiments, the data repository 712, or parts thereof, may correspond to the analytics database 516 in FIG. 5.

Once the threat actor detections 706 in the data repository 712 have been analyzed and a threat actor computer system has been selected (step 608 in the method 600 in FIG. 6) and the scouting protocol has been determined (step 610 in the method 600 in FIG. 6 or a default scouting protocol), the API 710 will transmit a message to initiate a new session with certain specifications; this message is placed on an interaction service bus 736. The presence of that message on the interaction service bus will cause the system to spin up a container 734. The container 734 provides one or more abiotic site interaction agents 738 and includes site identification and workflow models 740 and feature extraction functions for the abiotic site interaction agents 738. In the illustrated embodiment, the abiotic site interaction agent(s) 738 may be used as both abiotic digital scouting agents and/or abiotic digital seeding agents, depending on the configuration. Thus, the container 734 and associated abiotic site interaction agent(s) 738 may support covert digital reconnaissance of the threat actor computer system(s) (step 612 in the method 600 in FIG. 6) and may also support seeding the synthetic user identities into the threat actor computer system(s) (step 616 in the method 600 in FIG. 6). The container 734 and associated abiotic site interaction agent(s) 738 may be controlled by the interaction management agent 522 (FIG. 5). In other embodiments, distinct and separate specialized abiotic digital scouting agents and abiotic digital seeding agents may be provided instead of a configurable site interaction agent.

The abiotic site interaction agent(s) 738 can function as abiotic digital scouting agents to interact with a threat actor computer system 743 hosting a phishing website 744 to perform covert digital reconnaissance of the threat actor computer system(s) hosting the phishing website to identify respective characteristics of the threat actor computer system(s) via the feature extraction functions 742. These characteristics may include, for example, page flow information 716, metadata 718, HTML pages 726, certificates 728 and screenshots 730, and the identified characteristics are returned to the API 712 via an interaction receipt 746 for storage in the interaction and hosts store 732 and blob storage 724. The site interaction agents 738 may use the fingerprint characteristics when interacting with the threat actor computer system 743 hosting a phishing website 744 to perform covert digital reconnaissance.

Once the characteristics of the threat actor computer system(s) have been used to determine the seeding protocol, the abiotic site interaction agent(s) 738 can function as abiotic digital seeding agents to interact with the threat actor computer system 743 hosting the phishing website 744 to seed the synthetic user identities into the threat actor computer system(s) hosting the phishing website, according to the seeding protocol. The abiotic digital seeding agents interact with the threat actor computer system 743 hosting the phishing website 744 via a computer network. Like the covert digital scouting, the seeding of the synthetic user identities is covert in that it is designed to obscure the true source of the synthetic user identities and avoid alerting the threat actor operating the respective threat actor computer system. The synthetic user identities may be drawn from a credential pool 748, which stores device profiles 750 and bait users 752 each comprising an identifier (e.g. identifier 512 in FIG. 5, such as a card number) and preferably also comprising a password. The credential pool 748 may be, for example, the credential pool 524 shown in FIG. 5. If the covert digital reconnaissance identified anti-bot features like CAPTCHA or reCAPTCHA, then the abiotic site interaction agent(s) 738 may engage an anti-bot bypass service 754, which may include any commercially available service for CAPTCHA bypass, or custom-implemented CAPTCHA bypass techniques, to defeat the anti-bot features of the phishing website 744. As with the covert digital reconnaissance, the results of the seeding operation can be returned to the API 712 via interaction receipt 746.

Training functionality is also supported by the system 700 shown in FIG. 7. In one embodiment, the API 712 can invoke a site cloner 756. The site cloner 756 can use information about one of the phishing pages 744 captured by the covert digital reconnaissance (e.g. HTML pages 726 and certificates 728) to create a defanged clone 758 of the phishing website 744. The defanged clone 758 is “defanged” in that any code that communicates with the threat actor computer system(s) or is otherwise harmful (e.g. downloading of keystroke loggers, “man-in-the-middle” code or other malware) is removed and replaced with benign code or modified to obviate the harm. Preferably, communication with the defanged clone 758 is subject to at least a partial airgap to inhibit harmful communication. The defanged clone 758 of the phishing website 744 is hosted on a defanged clone host server 760. The defanged clone 758 of the phishing website 744 can be used for interaction testing of the site interaction agents 738, with the results returned to the API 710 and used for training and enhancement 764 of the site identification and workflow models 740 used by the site interaction agents 738. Communication with the defanged clone host server 760, and therefore with the defanged clone 758 of the phishing website 744, is mediated by an “identification, friend or foe” (IFF) server 762. The IFF server 762 is configured to permit the site interaction agents 738 to access the defanged clone 758 of the phishing website 744, but to prevent genuine human individuals from inadvertently interacting with the defanged clone 758 of the phishing website 744. Although such users would not be harmed because the defanged clone 758 is “defanged”, they would waste time interacting with the defanged clone 758 and would probably be annoyed. Moreover, if the phishing website 744 that was cloned and defanged was sophisticated, a genuine user interacting with the defanged clone 758 could be misled into thinking that certain transactions (e.g. bill payments) had been completed when in fact they had not. The IFF server 762 obviates the risk of genuine users interacting with the defanged clone 758.

A user interface 766 may be provided to enable security personnel to obtain information from, and provide input to, API 710.

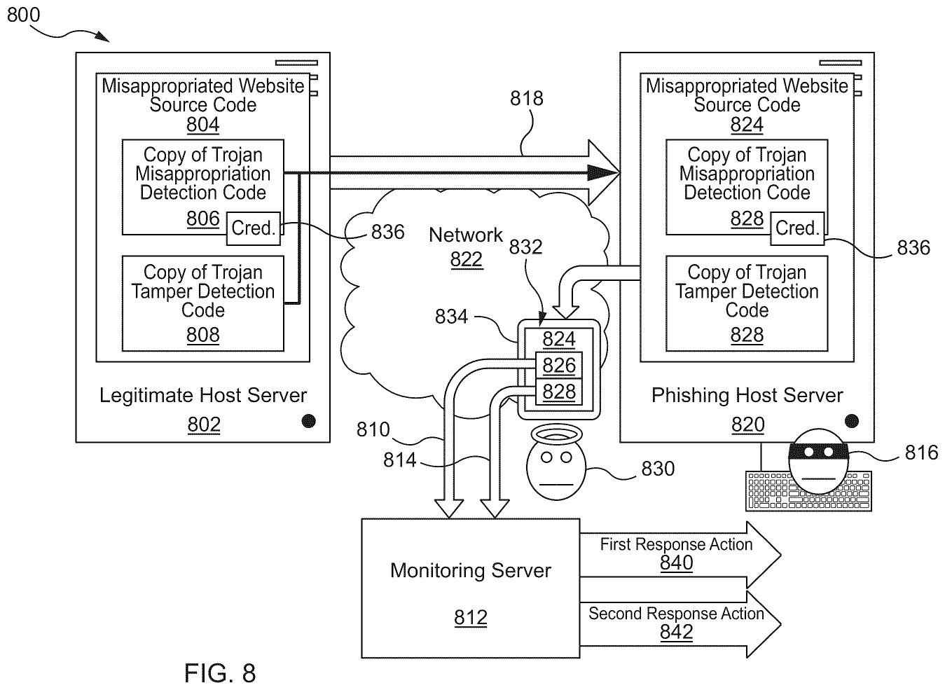

As noted above, in some embodiments the ongoing threat actor signals collected at step 602 of the method 600 include compromised code beacons. Reference is now made to FIG. 8, which shows a pictorial representation 800 of illustrative methods of proactively detecting misappropriation of website source code using compromised code beacons.

A legitimate host server 802 (which may be one or more interconnected computer systems) hosts website source code 804, which may comprise HTML code, JavaScript code and CSS code, for example. The website source code 804 may be, for example, for online banking services that permit users to log in using user accounts that give them access to various computer-implemented banking services, such as bill payments and online fund transfers. Thus, the legitimate host server 802 may be one or more of the servers 108 shown in FIGS. 1 and 2, for example. This is merely an illustrative, non-limiting, non-exhaustive example and the website source code 804 may be for a wide range of other services, for example an online streaming service, or an online retailer, or an online auction service, among others.

The legitimate host server 802 maintains first and second beacons 806, 808 embedded within the website source code 804. The first beacon 806 is adapted to transmit a first signal 810 to a monitoring server 812 upon execution of the website source code 804, for example in a web browser 832, in at least some cases of said execution. The second beacon 808 is adapted to detect tampering with the first beacon 806 upon execution of the website source code 804, for example in the web browser 832, and, responsive to detecting tampering with the first beacon 806, transmit a second signal 814 to the monitoring server 812. Both the first signal 810 and the second signal 814, when transmitted, will identify the domain (e.g. IP address, domain name, URL) of the host server hosting the website source code 804. The monitoring server 812, which may be comprised of one or more interconnected computer systems, may be one or more of the servers 108 shown in FIGS. 1 and 2, for example. Although shown as separate components for simplicity of illustration, in operation the legitimate host server 802 and the monitoring server 812 may be the same computer system (or group of interconnected computer systems), and the legitimate host server 802 and the monitoring server 812 may comprise shared hardware, or may be hosted on different hardware from one another.

In one embodiment, the first beacon 806 comprises Trojan misappropriation detection code embedded in the website source code 804. The Trojan misappropriation detection code may comprise JavaScript code adapted to incorporate domain identification data (e.g. identifying the IP address, domain name, or URL) for a host server hosting the website source code 804 into a payload of a resource request (e.g. GET or POST); thus, the first signal 810 may take the form of a resource request. More particularly, the domain identification data may be incorporated into a misappropriation detection request text string for a Trojan misappropriation detection resource request. For example, values may be appended to a text string for the resource request. In some embodiments, certain values may be appended as query parameters; in some instances the query parameters may duplicate, reference or be derivative of information contained in the payload (which may itself be a query parameter) of the resource request so as to provide for tamper detection. In one non-limiting, non-exhaustive illustrative embodiment, a query parameter may contain a hash or checksum of a payload value. Optionally, the request text string further incorporates user data for a user whose web browser transmitted the Trojan misappropriation detection resource request. The term “Trojan”, as used herein, is used in the context of the “Trojan horse” from the legendary retelling of the mythological Trojan War. According to this retelling, the Trojan horse was a hollow wooden horse concealing Greek soldiers which was accepted into the city of Troy as a gift, allowing the Greek soldiers to open the gates of the city from inside. Accordingly, the term “Trojan” as used herein refers to something which appears outwardly innocuous but conceals an adversary. Thus, the Trojan misappropriation detection code appears to be innocuous code for a resource request, but is in fact a first beacon 806 that will generate a resource request that serves as a first signal 810 to identify the domain of the host server hosting the website source code 804. In preferred embodiments, the resource request is an image request; it is typical for website source code to generate numerous image requests and therefore code that generates image requests is likely to appear more innocuous than code for generating other types of resource requests; nonetheless, other types of resource requests may also be used. Moreover, in one embodiment, the image request may be a request for an image file comprised of a single pixel, making it even more inconspicuous; typically, the Trojan misappropriation detection code 806 will send the image request but will not actually render the single pixel. The image request may be an image request for an image in any image format. In some embodiments, the monitoring server 812 may store an image which appears innocuous to a malefactor and may return that image in response to an image request therefor.

Of note, the Trojan misappropriation detection code is not limited to JavaScript code adapted to incorporate domain identification data into a resource request. For example, and without limitation, the first beacon 806 may comprise Trojan misappropriation detection code that includes JavaScript code to generate a cookie that includes the relevant information. Other implementations are also contemplated.

In some embodiments, the second beacon 808 comprises Trojan tamper detection code that is adapted to detect tampering with the first beacon 806 (e.g. Trojan misappropriation detection code) during execution of the website source code 804 and, responsive to detecting such tampering with the Trojan misappropriation detection code 806, transmit a tamper detection Trojan resource request; the second signal 814 may thus be a tamper detection Trojan resource request. The Trojan tamper detection code 808 may also comprise JavaScript code. The Trojan tamper detection code 808 may be adapted to detect tampering with the Trojan misappropriation detection code 806 by comparing a script file for the Trojan misappropriation detection code 806 as hosted to a stored value. In one particular non-limiting, non-exhaustive embodiment, a hash of the script file for the Trojan misappropriation detection code 806 may be compared to a stored hash value. The Trojan tamper detection code 808 may be adapted to incorporate domain identification data for a host server hosting the website source code 804 into a resource request; thus, the second signal 814 may take the form of a resource request, with the domain identification data (and optionally user data) incorporated into a tamper detection request text string for the Trojan tamper detection resource request.

The monitoring server 812 monitors for both the first signal 810 and the second signal 814. Optionally, to provide further obfuscation, the monitoring server 812 may comprise two distinct servers, each with a different domain, with one monitoring for the first signal 810 and the other monitoring for the second signal 814. Both the legitimate host server 802 and the monitoring server 812 may be part of the data center 106 shown in FIG. 1. In some embodiments, there may be a single monitoring server 812 (or a single monitoring server 812 for each beacon 806, 808) for all of the website source code 804 that is to be monitored, even if hosted on multiple legitimate host servers 802. In other embodiments, there may be a different monitoring server 812 (or a different pair of monitoring servers 812 for respective ones of the beacons 806, 808) for each unique unit of website source code 804 (i.e. each unique website).

The monitoring server 812 is configured to decode the resource request to extract the information embodied therein, including the domain identification data. In preferred embodiments, the beacons 806, 808 may have a standardized format to facilitate information extraction by the monitoring server 812. Moreover, aspects of this standardized format may be preserved if enhancements are made to the features or information content of the beacons 806, 808 to maintain backward compatibility and limit the need to change the backend configuration on the monitoring server 812.

Consider where a malefactor 816 misappropriates 818 some or all of the website source code 804 for use in setting up a phishing website on a phishing host server 820, for example by accessing the legitimate host server 802 via a network 822, such as the Internet, and using developer functionality of a web browser to copy the website source code 804. The malefactor 816 will likely have copied the website source code 804 in order to create a phishing website for malevolent ends. Since the beacons 806, 808 are disguised as resource requests, although the misappropriated website source code 824 will have been modified from the website source code 804 to suit the purposes of the malefactor 816, the misappropriated website source code 824 will in many if not most cases still include respective copies 826, 828 of the first beacon 806 and/or the second beacon 808. When an innocent user 830 accesses the phishing website on the phishing host server 820, the misappropriated website source code 824, with the copies 826, 828 of the beacons 806, 808, will be loaded into a web browser 832 executing on the user's device 834. Upon execution of the misappropriated website source code 824 in the web browser 832, the copy 826 of the first beacon 806 will transmit the first signal 810 to the monitoring server 812, which can then initiate a first response action 840. Since the misappropriated website source code 824 is hosted by the phishing host server 820, the first signal 810 identifies the domain of the phishing host server 820, so that after decoding by the monitoring server 812, appropriate action may be taken.

In some embodiments, the first beacon 806 may be adapted to transmit the first signal 810 in all cases upon execution of the website source code 804; that is, without first attempting to determine whether the domain of the host server hosting the website source code 804 is legitimate. Thus, the first signal may also be transmitted where the website source code 804 is downloaded from the legitimate host server 802 and executed by a web browser in a user device. In an embodiment in which the first beacon 806 is adapted to transmit the first signal 810 in all cases, the first response action 840 by the monitoring server 812 comprises determining whether the domain of the host server is unfamiliar. For example, the monitoring server 812 may compare the domain of the host server to a list of familiar domains, which list may include at least one of a localhost domain (e.g. “127.0.0.1” or “::1”) and at least one private domain, i.e. one or more RFC1918 compliant IP addresses. If the monitoring server 812 determines that domain of the host server is unfamiliar, the monitoring server 812 can provide one of the input channels 705 (FIG. 7) and the domain of the phishing host server 820 may be included as (or within) one of the threat actor signals 704 (FIG. 7) collected at step 602 of the method 600 (FIG. 6). The monitoring server 812 may provide an immediate alert to security personnel, as part of the first response action 840 or as a distinct action, or may defer such alert pending implementation of the method 600 shown in FIG. 6, which may provide further information to enrich such an alert. Deferral of an alert is not preferred, however, unless the particular implementation of the method 600 is sufficiently fast to minimize the risk of harm associated with a delayed alert.

Preferably, however, the first beacon 806 (and its copy 826) is adapted to determine whether the domain of the host server is unfamiliar, and to transmit the first signal 810 only if the domain of the host server is unfamiliar, which may be determined by comparison to a list of familiar domains as described above. This approach reduces the load on the monitoring server 812, since the first signal 810 will only be transmitted in a case where the host server is unfamiliar. Again, the monitoring server 812 can provide one of the input channels 705 (FIG. 7) and the domain of the phishing host server 820 may be included as (or within) one of the threat actor signals 704 (FIG. 7) collected at step 602 of the method 600 (FIG. 6). There is a trade-off, however, in that where the first beacon 806 is adapted to determine whether the domain of the host server is unfamiliar, it will necessarily include additional code for doing so, and this additional code may increase the likelihood that a skilled malefactor 816 may detect the first beacon 806.

In some embodiments, in addition to identifying the domain of the host server hosting the website source code 804, the first signal 810 further contains user credential information for identifying a compromised user. A compromised user is one who has submitted information to a phishing website. For example, the user 830 may have entered his or her user name, bank card number and/or credit card number, along with a password, into form fields on an HTML page on the web browser 832 of their device 834 and that information may have been transmitted to the phishing host server 820.

In one embodiment, the legitimate host server 802 maintains Trojan credential capture code 836 embedded within the website source code 804. The Trojan credential capture code 836 is adapted to capture user credentials transmitted to the host server (e.g. phishing host server 820), and, responsive to capturing the user credentials, transmit user credential information identifying the user credentials to the monitoring server 812. In preferred embodiments, the Trojan credential capture code 836 is comprised within the first beacon 806 so that the first signal 810 includes the user credential information; in other embodiments the Trojan credential capture code may be independent of the first beacon. In a preferred embodiment, any error in execution of the Trojan credential capture code 836 will trigger a further resource request from the first beacon 806 to the monitoring server 812, which resource request encapsulates the URL, error code (if any) and error message (if any), for example in its payload. In other embodiments, additional error checking may be performed, with additional detected errors triggering corresponding additional resource requests. In this context, an “error” is distinguished from tampering; an “error” refers to a malfunction or unexpected event during execution of an untampered instance of the Trojan credential capture code 836.

It is preferred that a determination be made as to whether the domain of the host server is unfamiliar, and that the user credential information be transmitted only if the domain of the host server is unfamiliar. For example, in one preferred embodiment the Trojan credential capture code 836 is comprised within the first beacon 806 and the first beacon 806 is adapted to determine whether the domain of the host server is unfamiliar, and to transmit the first signal 810, including the user credential information, only if the domain of the host server is unfamiliar.

The Trojan credential capture code 836 may, for example, be adapted to detect a “submit” action in HTML (where form field data is submitted to a form-handler), capture the HTML form field data and either incorporate at least a portion of the captured form field data into the user credential information, or extract information identifying the user credentials from the form field data and incorporate the extracted information into the user credential information. Alternatively, the Trojan credential capture code 836 may be adapted to detect a change event that is triggered without a “submit” action, for example, moving from one text form field to another, which may increase the likelihood of successful detection. In a preferred embodiment, the Trojan credential capture code 836 may validate some or all of the entered credentials before transmitting the resource request; for example, checking that a credit card number matches a known format (e.g. no letters, correct number of digits, Luhn valid).

The Trojan credential capture code 836 may also be adapted to capture client browser data and incorporate the captured client browser data into the user credential information. In some embodiments, the Trojan credential capture code 836 may be adapted to apply hashing to produce hashed information and include the hashed information into the user credential information. The use of hashing limits further risk to a compromised user.

The user credential data may be used to enrich the threat actor activity data, i.e. the threat actor detections 706 stored in the data repository 712 (see FIG. 7) as part of threat actor activity data maintained therein; this may be done asynchronously where the user credential data relates to an existing one of the threat actor detections 706.

Of note, in preferred embodiments the Trojan credential capture code 836 does not actually block or obstruct transmission of the user credentials as the code to implement such functionality could be more easily detected by the malefactor 816, as could the actual failure of the “submit” action or other change event; instead, the monitoring server 812 can be configured to take action to protect the user. For example, the monitoring server 812 can, directly or through interaction with other computer systems, lock the user's bank account or credit card, and alert the user, for example via a text message or a telephone call. Where automated, such remedial action can often be taken before the malefactor 816 can make nefarious use of the user credentials. This may proceed in parallel with the method 600 shown in FIG. 6.

As noted above, there is a risk that the malefactor 816 may detect the first beacon 806. It is possible that if the malefactor 816 is sophisticated, the malefactor may modify the misappropriated website source code 824 to tamper with and disable the copy 826 of the first beacon 806. Should this occur, so long as the copy 828 of the second beacon 808 remains intact, execution of the misappropriated website source code 824 will cause the copy 828 of the second beacon 808 to detect the tampering with the copy 826 of the first beacon 806, and, in response, transmit the second signal 814 to the monitoring server 812. Because the misappropriated website source code 824 is hosted by the phishing host server 820, the second signal 814 also identifies the domain of the phishing host server 820 so as to facilitate a suitable response. The monitoring server 812 can then initiate a second response action 842. For example, the monitoring server 812 can provide one of the input channels 705 (FIG. 7) and one of the threat actor signals 704 (FIG. 7) collected at step 602 of the method 600 (FIG. 6) may include the domain of the phishing host server 820 along with an indication that tampering with the copy 826 of the first beacon 806 has been detected. An alert to security personnel may also be provided, either immediately or after enrichment by execution of the method 600 (FIG. 6).

While the embodiment in which a second beacon 808 (or copy 828 thereof) is used to detect tampering with the first beacon 806 (i.e. the copy 826 thereof) is preferred; in some embodiments the second beacon 808 may be omitted and only the first beacon 806 will be embedded in the website source code 804.

Various obfuscation techniques may be deployed to conceal the first beacon 806 and the second beacon 808 and their respective resource requests; these techniques are familiar to those of ordinary skill in the art and are not described in detail here. Timing of the respective resource requests may be configured to increase the likelihood of successful triggering of the resource request in the appropriate context while reducing the likelihood of detection.

As can be seen from the above description, the methods for remediation targeting a threat actor computer system described herein represent significantly more than merely using categories to organize, store and transmit information and organizing information through mathematical correlations. The remediation methods are in fact an improvement to the technology of computer security, and to the technology of phishing countermeasures in particular; the remediation methods are confined to computer security applications, and in particular to phishing countermeasures. Thus, the present disclosure is directed to the resolution of a computer problem, specifically how to identify and disrupt phishing operations. Aspects of the present disclosure improve the functionality of phishing countermeasures by first gathering data via covert digital reconnaissance of a threat actor computer system hosting a phishing website and then using the data to determine and implement a seeding protocol to disrupt the phishing operations. The covert digital reconnaissance improves the performance of the seeding operation by identifying relevant characteristics of the threat actor computer system hosting the phishing website so that the seeding protocol can be suitably tailored. The use of seeded user credentials by a threat actor can provide a signal to enable detection of unauthorized login attempts with captured genuine credentials. This facilitates the ability to protect computer accounts against unauthorized access; improving the effectiveness of the seeding can improve the likelihood that the seeded synthetic user identities will effectively dilute the credentials of real victims and/or be used for a login attempt and increases the likelihood of detecting and blocking unauthorized login attempts with captured genuine credentials. As such, the technology is confined to computer security applications. Key features of the present disclosure describe and enable automation of covert digital reconnaissance of a threat actor computer system, determination of a seeding protocol, and seeding of a threat actor computer system with synthetic user identities according to the seeding protocol. This automation obviates the requirement for manually running covert digital reconnaissance and manually controlling the seeding of synthetic user identities. Importantly, however, the present disclosure is not directed merely to the automation of a manual process by generic computer processing of mathematical calculations, but rather describes specific functional computer technology that enables the automation. Moreover, the concept of seeding a threat actor computer system with synthetic user identities is confined to the computer context and has no mental analogue.

The present technology may be embodied within a system, a method, a computer program product or any combination thereof. The computer program product may include a computer readable storage medium or media having computer readable program instructions thereon for causing a processor to carry out aspects of the present technology. The computer readable storage medium can be a tangible, non-transitory device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present technology may be assembler instructions, instruction-set-architecture (ISA) instructions, machine instructions, machine dependent instructions, microcode, firmware instructions, state-setting data, or either source code or object code written in any combination of one or more programming languages, including an object oriented programming language or a conventional procedural programming language. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to implement aspects of the present technology.

Aspects of the present technology have been described above with reference to flowchart illustrations and/or block diagrams of methods, apparatus (systems) and computer program products according to various embodiments. In this regard, the flowchart and block diagrams in the Figures illustrate the architecture, functionality, and operation of possible implementations of systems, methods and computer program products according to various embodiments of the present technology. For instance, each block in the flowchart or block diagrams may represent a module, segment, or portion of instructions, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Some specific examples of the foregoing may have been noted above but any such noted examples are not necessarily the only such examples. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, other programmable data processing apparatus, or other devices to function in a particular manner, such that the instructions stored in the computer readable storage medium produce an article of manufacture including instructions which implement aspects of the functions/acts specified in the flowchart and/or block diagram block or blocks. The computer readable program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description has been presented for purposes of illustration and description, but is not intended to be exhaustive or limited to the form disclosed. Many modifications and variations will be apparent to those of ordinary skill in the art without departing from the scope of the claims. The embodiment was chosen and described in order to best explain the principles of the technology and the practical application, and to enable others of ordinary skill in the art to understand the technology for various embodiments with various modifications as are suited to the particular use contemplated.

One or more currently preferred embodiments have been described by way of example. It will be apparent to persons skilled in the art that a number of variations and modifications can be made without departing from the scope of the claims. In construing the claims, it is to be understood that the use of a computer to implement the embodiments described herein is essential.

What is claimed is:

1. A computer-implemented method for remediation targeting a threat actor computer system, comprising:
automatically collecting ongoing threat actor signals from a plurality of input channels;
automatically processing the threat actor signals to instantiate threat actor detections from the threat actor signals and storing the threat actor detections in a data repository as part of threat actor activity data maintained within the data repository;
automatically analyzing the threat actor detections in the data repository to select at least one threat actor computer system;
automatically using abiotic digital scouting agents to perform covert digital reconnaissance of the at least one threat actor computer system according to a scouting protocol to identify respective characteristics of the at least one threat actor computer system;
automatically using the characteristics of the at least one threat actor computer system identified by the abiotic digital scouting agents to determine a seeding protocol;
automatically using abiotic digital seeding agents to seed a plurality of synthetic user identities into the at least one threat actor computer system; and
returning to the step of automatically collecting the ongoing threat actor signals from the plurality of input channels.

2. The method of claim 1, further comprising, before using the abiotic digital scouting agents to perform the covert digital reconnaissance of the at least one threat actor computer system, automatically determining the scouting protocol for the abiotic digital scouting agents based on the respective threat actor signals for the at least one threat actor computer system.

3. The method of claim 1, wherein the threat actor signals comprise at least one of malicious website URLs, detected threat actor activity, compromised code beacons and compromised user credentials.

4. The method of claim 1, wherein the input channels comprise at least two of at least one phishing-site detection product, at least one anti-phishing software product, at least one abuse feed, and at least one login attempt.

5. The method of claim 4, wherein the threat actor signals are obtained from the at least one login attempt by:
monitoring, at a server system hosting the genuine login page, for login attempts for which the synthetic user identities are used for the login attempts;
comparing the synthetic user identities that are used for the login attempts to an entire set of the synthetic user identities that were seeded into the at least one threat actor computer system; and
determining, from the comparison, behaviour characteristics of at least one respective threat actor associated with the at least one threat actor computer system.

6. A data processing system comprising at least one processor and memory coupled to the at least one processor, wherein the memory contains instructions which, when executed by the at least one processor, cause the data processing system to carry out the method of claim 1.

7. A computer program product comprising at least one tangible, non-transitory computer-readable medium embodying instructions which, when executed by at least one processor of a data processing system, cause the data processing system to carry out the method of claim 1.

8. A computer-implemented method for obstructing phishing, comprising:
generating a pool of synthetic user identities, wherein each synthetic user identity comprises a set of user credentials, the set of user credentials including a numerical identifier having a same number of digits as a predefined structure;
wherein the pool of synthetic user identities comprises at least one of:
a set of pseudo-genuine synthetic user identities wherein, for each pseudo-genuine synthetic user identity in the set of pseudo-genuine synthetic user identities, the numerical identifier of that pseudo-genuine synthetic user identity passes all authentication tests corresponding to the predefined structure; and
a set of deficient synthetic user identities wherein, for each deficient synthetic user identity in the set of deficient synthetic user identities, the numerical identifier of that deficient synthetic user identity passes only some of the authentication tests corresponding to the predefined structure; and
using the user credentials to seed a plurality of the synthetic user identities from the pool into a phishing website impersonating a genuine login page.

9. The method of claim 8, wherein the set of user credentials further comprises a password.

10. The method of claim 8, wherein the pool of synthetic user identities comprises only the set of pseudo-genuine synthetic user identities.

11. The method of claim 8, wherein the pool of synthetic user identities comprises only the set of deficient synthetic user identities.

12. The method of claim 8, wherein:
the pool of synthetic user identities comprises both the set of pseudo-genuine synthetic user identities and the set of deficient synthetic user identities; and
the plurality of the synthetic user identities from the pool that are seeded into the phishing website comprises:
at least a subset of the set of pseudo-genuine synthetic user identities; and
at least a subset of the set of deficient synthetic user identities.

13. The method of claim 8, wherein each synthetic user identity is seeded only once.

14. The method of claim 8, wherein the numerical identifiers for the set of pseudo-genuine synthetic user identities are blacklisted transaction card numbers that are otherwise fully compliant with the predefined structure.

15. The method of claim 8, further comprising:
monitoring, at a server system hosting the genuine login page, for login attempts for which the synthetic user identities are used for the login attempts; and
comparing the synthetic user identities that are used for the login attempts to an entire set of the synthetic user identities that were seeded into the phishing website; and
determining, from the comparison, behaviour characteristics of a threat actor associated with the phishing website.

16. The method according to claim 15, wherein:
each of the synthetic user identities further comprises a set of user fingerprint characteristics; and
comparing the synthetic user identities that are used for the login attempts to the entire set of the synthetic user identities that were seeded into the phishing website comprises comparing the user fingerprint characteristics of the synthetic user identities that are used for the login attempts to the user fingerprint characteristics of the entire set of the synthetic user identities that were seeded into the phishing website.

17. A data processing system comprising at least one processor and memory coupled to the at least one processor, wherein the memory contains instructions which, when executed by the at least one processor, cause the data processing system to carry out the method of claim 8.

18. A computer program product comprising at least one tangible, non-transitory computer-readable medium embodying instructions which, when executed by at least one processor of a data processing system, cause the data processing system to carry out the method of claim 8.

19. A computer-implemented method for obstructing phishing, comprising:
generating a pool of synthetic user identities, wherein each synthetic user identity comprises a set of user credentials, the set of user credentials including an identifier and a password;
using the user credentials to seed a plurality of the synthetic user identities from the pool of synthetic user identities into a phishing website impersonating a genuine login page;
monitoring, at a server system hosting the genuine login page, for login attempts for which the synthetic user identities are used for the login attempts; and
comparing the synthetic user identities that are used for the login attempts to an entire set of the synthetic user identities that were seeded into the phishing website; and
determining, from the comparison, behaviour characteristics of a threat actor associated with the phishing website.

20. The method according to claim 19, wherein:
each of the synthetic user identities further comprises a set of user fingerprint characteristics; and
comparing the synthetic user identities that are used for the login attempts to the entire set of the synthetic user identities that were seeded into the phishing website comprises comparing the user fingerprint characteristics of the synthetic user identities that are used for the login attempts to the user fingerprint characteristics of the entire set of the synthetic user identities that were seeded into the phishing website.

21. The method of claim 19, wherein the pool of synthetic user identities comprises at least one of:
a set of pseudo-genuine synthetic user identities wherein, for each pseudo-genuine synthetic user identity in the set of pseudo-genuine synthetic user identities, the identifier of that pseudo-genuine synthetic user identity passes all authentication tests associated with the identifier; and
a set of deficient synthetic user identities wherein, for each deficient synthetic user identity in the set of deficient synthetic user identities, the identifier of that deficient synthetic user identity passes only some of the authentication tests associated with the identifier.

22. The method of claim 21, wherein:
the identifier is an e-mail address; and
the authentication tests associated with the e-mail address consist of a structural test and a response test.

23. A data processing system comprising at least one processor and memory coupled to the at least one processor, wherein the memory contains instructions which, when executed by the at least one processor, cause the data processing system to carry out the method of claim 19.

24. A computer program product comprising at least one tangible, non-transitory computer-readable medium embodying instructions which, when executed by at least one processor of a data processing system, cause the data processing system to carry out the method of claim 19.
